(19) United States
(12) Patent Application Publication
(10) Pub. No.: US 2014/0250043 A1
(43) Pub. Date: Sep. 4, 2014

(54) METHOD AND SYSTEM FOR MAINTAINING COGNITIVE ABILITIES

(71) Applicants: Yuval Malinsky, Newton, MA (US); Daphna Malinsky, Newton, MA (US)

(72) Inventors: Yuval Malinsky, Newton, MA (US); Daphna Malinsky, Newton, MA (US)

(21) Appl. No.: 14/224,517

(22) Filed: Mar. 25, 2014

Related U.S. Application Data
(62) Division of application No. 12/886,221, filed on Sep. 20, 2010.
Application No. 12/886,221 is a continuation of application No. 12/473,528, filed on May 28, 2009, now abandoned.

(51) Int. Cl. G06N 5/02

(52) U.S. Cl. CPC G06N 5/02
USPC 706/46

(57) ABSTRACT

A method and system for maintaining and improving cognitive abilities and functioning includes one or more modules that provide exercises and activities for exercising cognitive skill and provide an environment that promotes treatment adherence and emotional well being. The exercises and activities can be customized using content that is selected as a function of information obtained from a user profile. The system can prompt the user for information about the user and the user's preferences and this information can be stored in a user profile. The user profile can include information about the user and preferences of the user, such as their home town and what their favorite sports teams are and the system can select content which is related the to the user's hometown or favorite sports teams, including pictures of people, places and team logos. The system can also assist the user with selecting and achieving personal health and wellness goals by assisting the user in participating in a health and wellness program designed to achieve those goals and track the user's participating in and completion of the program. The system can provide the user with rewards for participating in and completing the program. The system can select the reward based on user preferences. The system can chart and display the user's progress toward receiving a reward.

### CROSS-REFERENCE TO RELATED APPLICATIONS

This application is a divisional of U.S. patent application Ser. No. 12/886,221, filed on Sep. 20, 2010, which is a continuation of U.S. patent application Ser. No. 12/473,528, filed on May 28, 2009, now abandoned, the entire disclosures of which are herein incorporated by reference in their entireties.

### STATEMENT REGARDING FEDERALLY SPONSORED RESEARCH

Not Applicable

### REFERENCE TO MICROFICHE APPENDIX

Not Applicable

### BACKGROUND

1. Technical Field of the Invention

The present invention relates to methods and system for maintaining and improving cognitive abilities of individuals and for promoting treatment adherence and emotional well being of individuals participating in programs designed to stimulate the brain and maintain or improve brain and/or physical wellness.

2. Description of the Prior Art

There are many systems in the prior art that are directed to maintaining and improving cognitive abilities or modifying behavior.

U.S. Pat. No. 6,632,174 by Shlomo Breznitz, and assigned to CogniFit, Ltd. is directed to a method and apparatus for testing and training cognitive ability. The system tests the user on 17 exercises and based on the results of the test it adjusts the order, frequency and level of the exercises that it includes in the user's training program. The system does not query the user about his/her user's background and/or interests at any time before, or along the training program, and does not build a background and interests profile of the user at any time before or along the training program. The system does not personalize the content of the exercises based on the user's background and interests profile at any time before or along the training program. The system does not offer rewards other than scores of the exercises. With no rewards the system does not personalize the rewards to address the user's background and interests profile at any time before or along the training program. The system does not address treatment adherence in any specific way.

U.S. Pat. Nos. 6,261,101, 6,629,844, 6,159,014 by Jenkins William M et al, and assigned to Scientific Learning Corporation are directed to a method and apparatus for training of cognitive and memory systems in humans. The system provides the user with selected portions of language elements, called phonemes, so they will be more easily distinguished by the subject, and gradually improves the subject's neurological processing and memory of the elements through repetitive stimulation. The programs continually monitor a subject's ability to distinguish the processed language elements, and adaptively configures the programs to challenge and reward the subject by altering the degree of processing. The system does not query the user about his/her user's background and/or interests at any time before, or along the training program, and does not build a background and interests profile of the user at any time before or along the training program. The system does not personalize the content of the exercises based on the user's background and interests profile at any time before or along the training program. The system offers the same rewards to each user. It does not personalize the rewards to address the user's background and interests profile at any time before or along the training program. The system does not address treatment adherence in any specific way.

U.S. Pat. Nos. 6,599,129 and 6,331,115 by Jenkins William M et al, and assigned to Scientific Learning Corporation are directed to a method for adaptive training of short term memory and auditory/visual discrimination within a computer game. The system does not query the user about his/her user's background and/or interests at any time before, or along the training program, and does not build a background and interests profile of the user at any time before or along the training program. The system does not personalize the content of the exercises based on the user's background and interests profile at any time before or along the training program. The system offers the same rewards to each user. It does not personalize the rewards to address the user's background and interests profile at any time before or along the training program. The system does not address treatment adherence in any specific way.

U.S. Pat. No. 6,641,402 by David Boggs is directed to a method and apparatus for training memory. The system does not query the user about his/her user's background and/or interests at any time before, or along the training program, and does not build a background and interests profile of the user at any time before or along the training program. The system does not personalize the content of the exercises based on the user's background and interests profile at any time before or along the training program. The system does not offer rewards other than scores of the exercises. With no rewards the system does not personalize the rewards to address the user's background and interests profile at any time before or along the training program. The system does not address treatment adherence in any specific way.

U.S. Pat. No. 6,565,359 by Calhoun Barbara et al, and assigned to Scientific Learning Corporation is directed to remote computer-implemented methods for cognitive and perceptual testing. The system does not query the user about his/her user's background and/or interests at any time before, or along the training program, and does not build a background and interests profile of the user at any time before or along the training program. The system does not personalize the content of the exercises based on the user's background and interests profile at any time before or along the training program. The system does not offer rewards other than scores of the exercises. With no rewards the system does not personalize the rewards to address the user's background and interests profile at any time before or along the training program. The system does not address treatment adherence in any specific way.

U.S. Pat. No. 6,039,688 by Douglas Peter, et al. and assigned to Salus Media Inc is directed to a therapeutic behavior modification program, compliance monitoring and feedback system. The system does not train cognitive skills. The system does not query the user about his/her user's background and/or interests at any time before, or along the training program, and does not build a background and interests profile of the user at any time before or along the training program. The system does not personalize the content of the exercises based on the user's background and interests profile at any time before or along the training program.

U.S. Pat. No. 5,967,789 by Segel; Joseph M et al, and assigned to Smoke Stoppers International, Inc. is directed to a method and system for stopping or modifying undesirable health-related behavior habits or maintaining desirable health-related behavior habits. The system does not train cognitive skills. The system does not personalize the content of the exercises based on the user's background and interests profile at any time before or along the training program.

Many senior citizens suffer from physical, cognitive and emotional losses associated with aging, disease, trauma and intervention. While there are programs including exercises and activities that can be used to help slow and possibly reverse these physical, cognitive and emotional losses, the systems of the prior art may demonstrate limited success because they suffer from poor compliance and/or adherence to a program or routine.

### SUMMARY

The present invention is directed to a method and a system for providing cognitive activities for maintaining or improving cognitive abilities and functioning. Cognitive activities are activities that initiate mental processing of sensory information (such as auditory and visual) that is experienced through the system software, and the mental manipulation of such information. Cognitive activities can be used to train one or more cognitive abilities, for example, attention, working memory, processing speed, perception and reasoning. These cognitive activities can potentially slow down cognitive decline, and help maintain or improve cognitive abilities and functioning. The system is adapted and configured to provide a user with an interactive environment that can present a user with a predefined or ad hoc program or schedule of activities that stimulate the brain and contribute to mental and emotional well being. The interactive environment can include one or more modules that can provide one or more activities or exercises. Each module can include one or more components or activities that can each include one or more exercises or components intended to maintain or improve cognitive ability. The system can monitor the progress and performance of the user with respect to the predefined or ad hoc program.

The system can also be adapted and configured to promote adherence (or compliance) to the program or to other user or caregiver defined health goals and promote the emotional well being of the user. The system can provide the user with rewards for participation (maintaining adherence), improvements in performance and program completion. In accordance with the invention, the system can query the user for information about the user that can be used to modify or tailor the interactive environment, the exercises and the rewards to the user. The system can, over a period of time or interactions, query the user about different aspects of their life and store the information in a user profile. Information from the user profile can be used to select the content that is presented to the user during their interactions with the system and the rewards provided to the user during the course of their interaction with the system. The selected content can be used to tailor the interactive exercises and the rewards to the user.

In accordance with implementations of the invention, one or more of the following capabilities may be provided.

It is one object of the invention to provide a system that maintains and/or enhances cognitive ability

It is another object of the invention to provide a system that slows down cognitive decline

It is another object of the invention to provide a system that promotes emotional well being

It is another object of the invention to provide a system that improves self efficacy

It is another object of the invention to provide a system that promotes compliance or adherence to a defined program;

It is another object of the invention to provide a system that assists those with declining cognitive abilities in organizing their life (Ex. Keeping appointments, remembering duties, etc.) and remembering what is important to them and in maintaining or prolonging functional independence.

These and other capabilities of the invention, along with the invention itself, will be more fully understood after a review of the following figures, detailed description, and claims.

### BRIEF DESCRIPTION OF THE FIGURES

FIG. 1 is a diagram of a system according to the invention.

FIG. 2 is a diagram of a Staying In Control module according to the invention.

FIG. 3 is a diagram of a visual spatial memory exercise with non-customized objects.

FIG. 4 is a diagram of the next step in the same visual spatial memory exercise with non-customized objects.

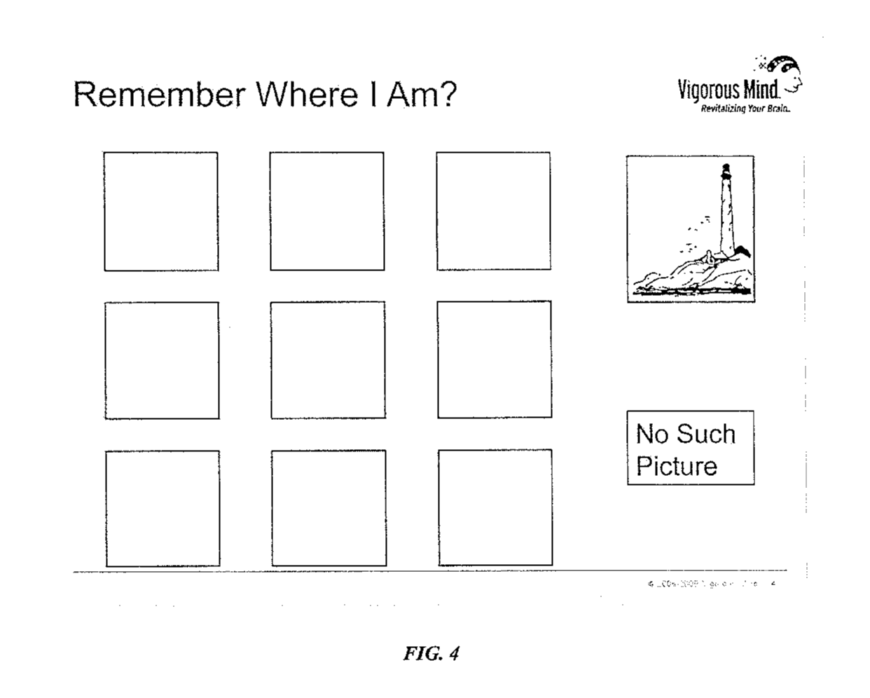

FIG. 5 is a diagram of the same visual spatial memory exercise with customized objects related to the user's past—Places where he grew up.

FIG. 6 is a diagram of the same visual spatial memory exercise with customized objects related to the user's family—Family members.

FIG. 7 is a diagram of the same visual spatial memory exercise with customized objects related to the user's family (Family members) used as a naming exercise.

FIG. 8 is a diagram of customized naming exercise where the pictures of the people and the names are of the user's family members.

FIG. 9 is a diagram of a scanning exercise where the people the user has to spot are customized—his/her favorite player.

FIG. 10 is a diagram of a connectivity system where the address book includes the pictures of the family members with whom the user communicates and customized recordings from such family members.

FIG. 11 is a diagram of recollections albums which are populated with pictures based on the custom information aggregated in the user's profile—the user mentioned being a Dodgers' fan and the picture is of Ebbets field.

FIG. 12 is a diagram of a 4×W (Who, What, When, Where) exercise providing short stories about what happened in history this week and the choice of stories is customized based on the user's profile.

FIG. 13 is a diagram of a My Music screen that is customized based on the profile that the system built on the user.

FIG. 14 is a diagram of a Staying Safe Driving exercise with signs that appear and disappear like a real driving experience.

FIG. 15 is a diagram of the next step in the Staying Safe Driving related exercise.

FIG. 16 is a flow chart of a method according to the invention.

FIG. 17 is a flow chart of a method according to the invention.

FIG. 18 is a flow chart of a method according to the invention.

FIG. 19 is a flow chart of a method according to the invention.

### DETAILED DESCRIPTION OF PREFERRED EMBODIMENTS

The present invention is directed to a system and method for providing cognitive activities for slowing cognitive decline, maintaining and/or improving cognitive abilities and functioning. A cognitive activity can be any activity that initiates mental processing of sensory information (such as auditory and visual) that is experienced through the system software, and the mental manipulation of such information. Cognitive activities can be used to train or exercise one or more cognitive abilities, such as, attention, working memory, processing speed, perception and reasoning. These cognitive activities stimulate brain structures and circuits and can potentially slow cognitive decline, maintain or improve cognitive abilities and functioning. A system and method according to one embodiment of the invention can promote adherence to a program of activities and/or exercises in order to achieve health related goals, such as a program designed for maintaining and/or improving cognitive ability. A system and method according to one embodiment of the invention can also be used to slow down cognitive decline, to promote emotional well being, to improve self efficacy, to assist those with declining cognitive abilities in organizing their life (Ex. keeping meetings, remembering duties) and remembering what is important to them, and in maintaining or prolonging functional independence.

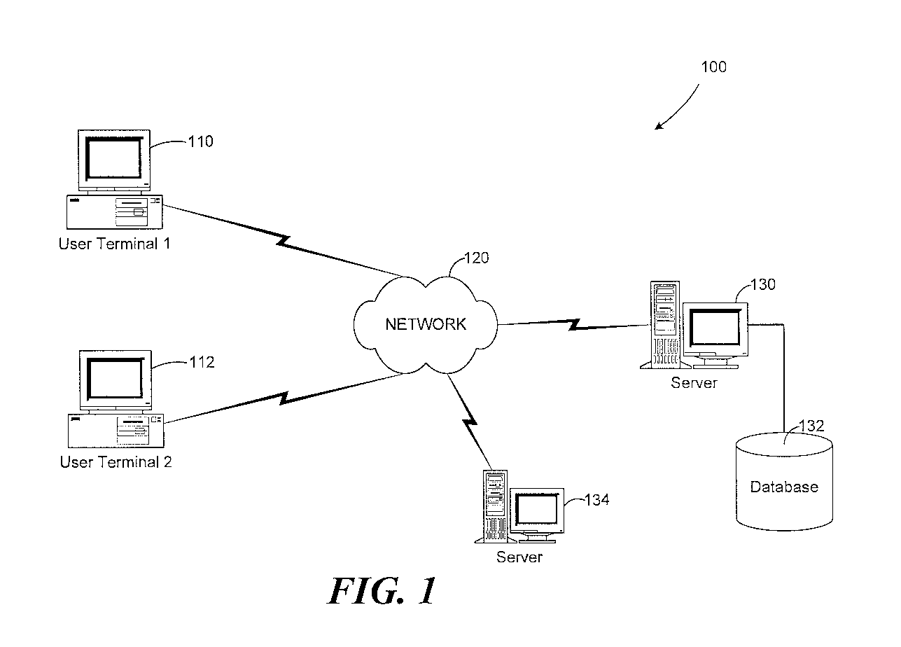

FIG. 1 shows a diagram of a system 100 according to the invention which can include one or more user terminals 110, 112, connected by a network 120 to one or more servers 130, 134. Each user terminal 110, 112 can be adapted and configured to transfer data over the network 120 to and from the servers 130, 134. The user terminal 110, 112 can provide a user interface for the User to interact with the system 100. The user terminals 110, 112 can present content from the servers 130, 134 to the user and cause user to interact with the system. In accordance with the invention, content can include pictures (graphic images), moving pictures or video, sound including music and other audio content, text, games and exercises and any combination of the forgoing content.

In one embodiment, the user terminal 110, 112 and the servers 130, 134 operate in a client-server environment where the user terminals 110, 112 act as clients requesting content from or sending information to one or more servers 130, 134 and receiving content from one or more of the servers 130, 134. The user terminal 110, 112 can be a computer terminal including a personal computer (for example, based on the Windows Intel, Linux or Mac platforms), a handheld computing device, such as a PDA, smart phone or ipod that can be connected to a wired or wireless network and provide a web browser user interface. In one embodiment, the user terminal 110, 112 is a desktop computer using a well known web browser to communicate with one or more servers 130, 134 over the network 120. The network 120 can be any public, private or proprietary network that enables the user terminal 110, 112 and the server 130 to communicate, including the Internet. The network 120 can include wireless (including, for example, WiFi, WiMAX, 3G, 4G, Bluetooth, Zigbee) and wired (including, for example, Ethernet, FDDI, optical) network technologies and can include the Internet.

The server 130, 134 can be any server architecture, including Windows, Linux, Unix or Mac based platforms that can receive requests and send content to the user terminal 110, 112 over the network 120. The server 130 can include a database 132 for storing data and content to be transferred over the network to the user terminal 110, 112. In other embodiments of the invention, the database 132 can be directly connected to the network 120.

In accordance with one embodiment of the invention, the server 130, 132, 134 can be a web server (such as Apache or Microsoft IIS) that communicates over the network 120 with the user terminal 110, 112 using HTTP or similar protocols. In operation, the user at the user terminal 110, 112 boots up the user terminal computing device and opens a web browser (such as, Microsoft Internet Explorer, Mozilla Firefox, or Google Chrome) and enters the URL (www.myvigorousmind.com) of a website on the Internet by either typing the URL or selecting a link from a web page or a menu entry.

In operation, the system 100 can maintain a profile for each user that contains information about the user. The user profile information can be stored in one or more files or in one or more records that are part of one or more databases.

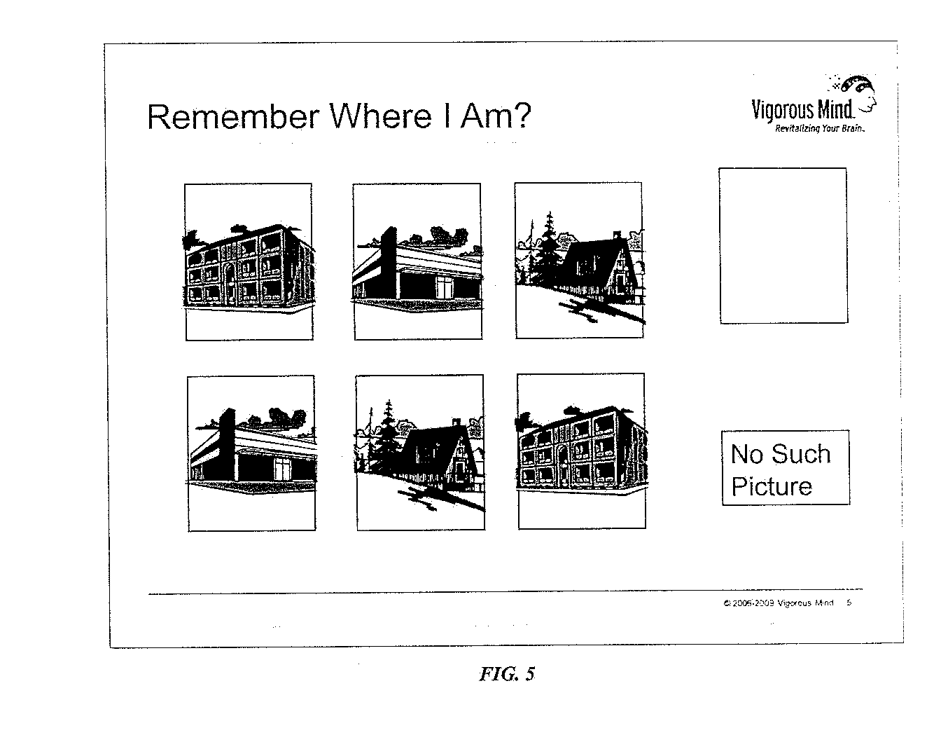

The system 100 can also maintain a database of content. The content can include pictures, sounds (including music, audio clips, and sound recordings), video and text, games and exercises that can be sent over the network 120 to the user. The content database can include either the actual content or a pointer (such as a link or URL) to the actual content which can be stored on another computer that is connected to the network 120. In addition, each item of content in the database can be associated with one or more attributes (for example, database fields or attributes) which can include information about the item of content or information which characterizes the item of content. The information can include a date or time period associated with the content and the subject of the content. For example, the pictures shown in FIG. 5 can include the attributes “Brooklyn,” “New York,” and “1955.”

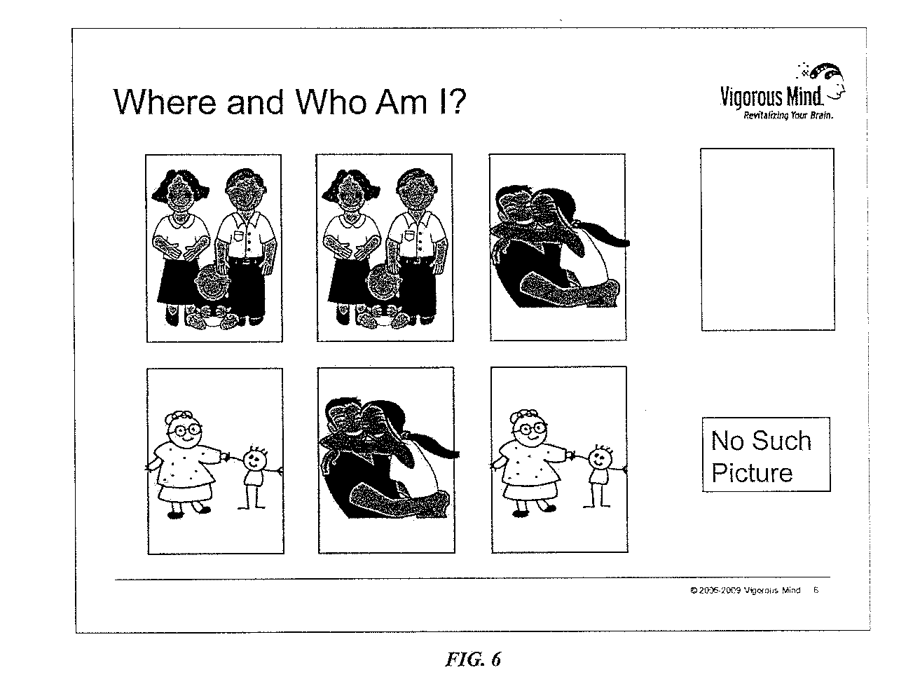

In accordance with one embodiment of the invention, the system 100 can also include content that is selected because it is determined to be familiar or relevant to the user, including content that is provided by the user, a family member of the user or the user's caregiver. The content can be stored on the user's terminal, server designated by the user (or their family member or caregiver) or the content database. Additional database attributes can be included to indicate the relationship between the content and the user. For example, the pictures shown in FIG. 6 can include the attributes “niece,” “Becky” (niece's name), “college graduation,” “brother's daughter,” “George” (brother's name). Other attributes can include the user's alma mater and year of graduation, and information that the user's niece graduated from the same university.

In accordance with the invention, additional attributes can be added to identify or define relevant information about the content to the user. In one embodiment of the invention, all the attribute information can be stored in a common database on one or more of the servers connected to the network. In an alternative embodiment, the attribute information can be distributed between several databases where some of the information is stored on the one or more servers connected to the network and some of the information is stored on the user's terminal.

In accordance with one embodiment of the present invention, the system and method can be embodied in a web-based portal and application software for maintaining and/or improving brain health and wellness. The software can query the user from time to time during his or her use of the software for information about his/her health related goals, background, family, education, work experience, interests, hobbies and important memories and use this information to build and update a user profile. The software can maintain a user profile that can include information about the user including the user's date and place of birth, places where the user lived, schools attended, work places, family members, favorite sports, teams and players, favorite music, and performers, favorite movies, directors, and actors, etc. The user profile can be used to enrich the user experience by identifying and providing links to content through public and private networks and the system database that can be used to customize the content provided by the software to the user with relevant media—pictures, audio clips and video clips and their URLs or pointers are then stored with the different elements in the profile. For example: If a user was born in Brooklyn, N.Y. in 1930 and lived there until 1948, pictures (links or URLs to pictures) of Brooklyn from that time can be included in any of the multiple activities where pictures are shown. If the user indicated that his favorite sport is Baseball and his favorite team was the Dodgers and Jackie Robinson was one of his heroes, pictures of the Dodgers and Jackie Robinson can be inserted into certain exercises, activities and rewards to customize them for this user. If a person has children and grandchildren, their pictures can be used to customize the exercises and activities the user performs and the rewards the user receives.

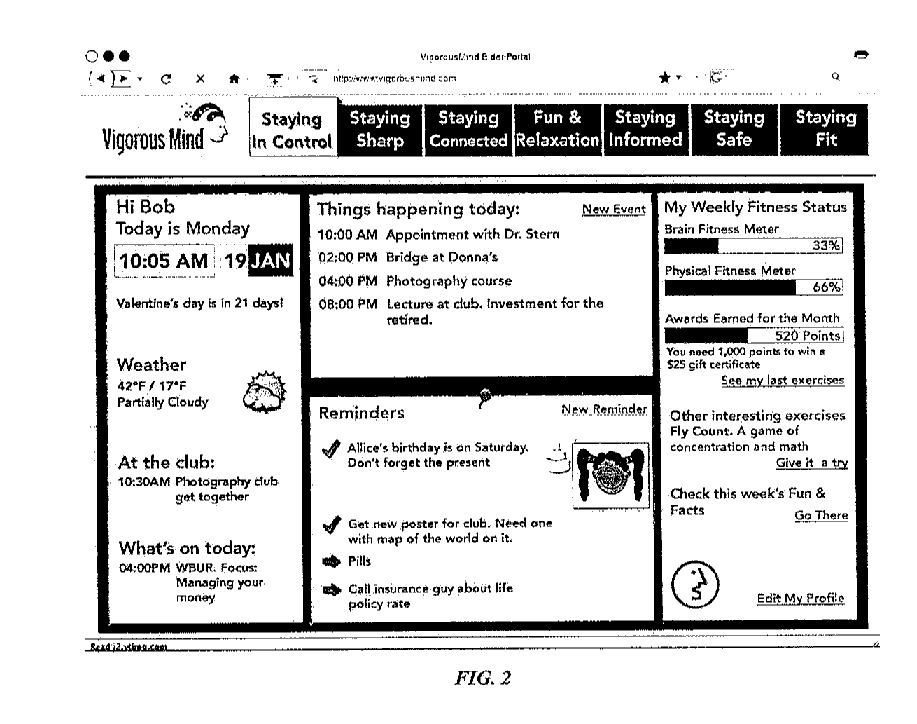

In accordance with one embodiment, the system 200, as shown in FIG. 2, can include seven components or modules. Each module can include one or more activities that can contribute to brain wellness and/or functioning. In addition, the content of each activity of each module can be customized for a user using content selected as a function of one or more of the information items stored in the user's profile. Some of the modules can include activities and exercises that contribute to maintaining or improving brain wellness that can provide the user with content customized rewards as a function of the user's participation and performance on exercises and activities.

In accordance with one embodiment of the invention, the seven modules can include Staying In Control, Staying Sharp, Staying Connected, Fun & Relaxation, Staying Informed, Staying Safe and Staying Fit.

In accordance with one embodiment of the invention, the Staying In Control module, as shown in FIG. 2 can include a customized dashboard that provides organizational and motivational tools. The Dashboard 210 can enable the user to quickly get oriented, understand his or her tasks (to do list), and see his or her fitness and adherence status. In one embodiment of the invention, the Dashboard can be divided into 3 areas, the orientation area 212, the “to do” area 214, 216 and the status area 218. The orientation area 212 allows the user to be oriented for the day by providing them information, including their name, the current date and time, the weather forecast, proximity to upcoming holidays or important dates chosen by the user (“Valentine's Day is in 21 days!” or “Your wife's birthday is in 14 days.”; “Your anniversary is in 30 days.”). The amount of time before the event date of a reminder can be user selectable. For example, the default reminder time can be 21 days, but the user can select a longer or shorter reminder of time (e.g. 30 days) for events that may require more time to prepare for. The orientation area 212 can also identify the next appointment or activity on the user's schedule as well as the next regularly scheduled activity or event (for example, favorite TV show or radio program) for the day.

The “to do” area 214, 216 can provide the user with a more complete view of the day's activities, including the activities and appointments 214 scheduled for the day as well as reminders 216 of things to be done. The “to do” area can also include a link or button that allows the user to add appointments or activities to their schedule and/or add reminders to the “to do” area for current day and/or days in the future.

The status area 218 can provide the user with the status of their wellness program, including an indication of their progress toward their wellness goals for the day, for the week or month and/or for the overall program. The status area 218 can also provide an indication of awards earned as well as a link to past exercises (or exercise sessions) and past rewards achieved for participation and completion of elements of the fitness program. In accordance with one embodiment of the invention, the wellness program can include a brain fitness program which can provide for maintaining and/or improving cognitive ability, a physical fitness program which can provide for maintaining and/or improving physical fitness or both. The status area 218 can include feedback on other health related goals such as weight loss status, substance abstinence status, etc. The status area 218 can provide links to the current day's scheduled or suggested exercises as well as links to suggested additional or alternative exercises for the user to try.

In any of the areas of the Staying In Control module, the user can select (such as by clicking or double clicking on) the items to get more information about that item as well as the ability to edit or modify the item. For example, clicking on any of the day, date or time items can bring up a calendar display, showing all the appointments, activities, events and holidays for the current day, week or month. The user can change the calendar view to display a day, week (or part of a week) a month (or part of a month) or year (or part of a year). In alternative embodiments, a separate user interface element, such as button or a link can be provided to allow the user to get more information about that item as well as the ability to edit or modify the item.

In accordance with one embodiment of the invention, clicking on an upcoming event can provide a display of the upcoming event including more detailed information about the event (activity locations, personal plans, etc.), any reminders associated with the event as well as other relevant information. For example, for Valentine's Day, the system could display the date of the event, a picture of each person identified by the user as a potential Valentine and a reminder area indicating the name of each person the user has chosen to send a valentine or get a gift for. A print function can be provided to enable the user to print out a list of names to use when shopping for Valentine's Day cards and/or gifts. Similarly, for each upcoming birthday, by clicking on the link, the user can be provided with a picture of the person whose birthday is upcoming as well as reminder to purchase a gift or card. The user can also be provided with a print function to enable the user print a list of names of people to shop for upcoming birthdays and other events/activities (anniversaries, thank you gifts/cards, etc.).

In accordance with one embodiment of the invention, clicking on any item can open a calendar that can show a daily, weekly or a monthly view and can enable insertion of activities and reminders. When inputting an event to the calendar, the user can choose from lists of people and places he/she typically visits or add new ones to his/her profile. When selecting such a known person or place, images and addresses stored in the profile can be shown in the daily calendar and can be printed in large font.

Reminders such as birthdays will automatically post on the To Do list based on the profile. Pictures of people, based on information stored in the user's profile and icons relevant to the activity (birthday, golf game, bridge game) can also be shown.

If the user, a family member or a caregiver chooses to enter his medications and treatment information to the software, the software will issue reminders when the medications are to be taken.

The user can click on the weather item or associated icon and see a more complete weather forecast from a weather source, such as The Weather Channel (www.weather.com). Clicking on the link can bring the user to the weather source's web site, for example, and display the details of today's weather or the weather forecast for the coming week. For some of the items, the action that occurs when the user clicks on an item or an icon associated with the item can be user programmable, for example, clicking on Today's Weather could bring the user to their favorite weather website, the full details of the current day's weather or the weather forecast for the coming week. In alternative embodiments of the invention, this feature can be expanded to include a drop-down menu or other menu that allows the user to select, for example, weather for their current city, their home town, their family's city and/or other friend's locations.

In accordance with one embodiment of the invention, the fitness and reward status area 218 can present status information based on the health goals that the user, a family member or a caregiver has input into the system. For example, a user can be assigned a goal of performing brain exercises three times a week for 40 minutes each time and the system software can create scales or bar graphs for brain fitness time measurement and the progress toward achieving the goal (for example, a percentage completed) can be shown. If the goal is burning a certain number of calories per week, a bar graph can be shown representing the amount of calories or the percentage of goal achieved. If the goal is adherence to (or attendance at) treatment meetings on a periodic basis (for example, weekly or monthly), a bar graph reporting the user's progress toward achieving that goal can be created and shown.

In addition to progress toward goals, the system can display progress toward receiving a reward. In accordance with one embodiment of the invention, a rewards earned bar graph can be provided. The rewards earned bar graph can be determined by combining the measurements (or progress) toward accomplishing goals from the user's goals bars and adding them to a score which shows how close a user is to receiving a reward. Since goals are personal, the calculation can be based on the user's efforts toward achieving his/her personal goals. The rewards can also be customized in their type and content. A user can define a “wish-list” of rewards and the system can present to the user his/her progress towards achieving such reward. For example: A Boston Celtics fan can have a wish-list that includes: A ticket to a regular season game, a ticket to a playoff game, a basketball signed by the players, a ticket to a game including a meeting with the players after the game.

In accordance with one embodiment of the invention, customization can occur on any or all of the seven modules or activities and any or all of the areas within each module or activity.

Initialization

In accordance with one embodiment of the invention, the first time a user uses the system, the system can provide the user with a series of prompts that present questions to the user for the user to answer. The answers to the questions can be used either directly or indirectly to determine the information input into the user's profile. In an alternative embodiment of the invention, some or all of the information requested by the prompts can be input by a user's family member or caregiver, such that the user does not have to participate in an initial setup and configuration process.

In accordance with one embodiment of the invention, the user can be asked by the software how he wishes to be addressed, the answer can be stored in the user profile and each subsequent time the user logs in or uses the system, the user can be greeted accordingly. The user can be asked about favorite activities each day (golf, bridge, visiting grandchildren, etc.) and will be reminded of such favorite activity if a related event is happening on that day. If the activity is related to a place/organization that has a website, clicking on the activity will assist the user with viewing that website. The user can be asked about favorite radio and/or TV programs and can be reminded of such favorite radio or TV program if the program is available during the day. Clicking on the reminder can bring up more information about the program from the website of the source.

The fitness and reward status area can be built by the software based on the health goals that the user specified. If, for example, the user defines a goal of performing brain fitness exercises three times a week for 40 minutes each time, the software can create a bar graph or scale for brain fitness completion time and the percentage of the goal completed can be shown. If the physical fitness goal is burning a certain number of calories per week, a bar graph or scale can be displayed indicating the percentage of calories burned for the week toward the goal. If the goal is adherence to (attendance or participation at) treatment meetings, a bar graph displaying progress toward that goal can be displayed. The type and form of the graph (for example, bar or line) can be different depending on the goal and the type of activity monitored. If the activity is measured by a simple numeric value, points or score over a long period (week or month, for example), a simple horizontal bar graph can be used to indicate the user's progress. Where the activity and the goal involves regular daily activity, a set of vertical bar graphs or a line graph can be used, for example, providing a separate bar indicating the user's performance for each day over the last week. The bars can be color coded to further indicate progress, for example, a red bar indicating the user is significantly behind, a yellow bar indicating the user is slightly behind, a green bar indicating the user is on track to meet their goal and a blue bar indicating the user is ahead of the projected goal.

In accordance with one embodiment of the invention, the system can provide the user with awards or rewards for progress toward and completion of their ultimate goal. Thus, if a goal of improving brain fitness involves 6 months of exercises or treatment sessions, the user can be provided with an award or reward for completing each month's program as well as an award or reward for completing the whole program. The software system can display an award/reward bar which indicates the user's progress toward receiving an award or reward. The award/reward bar can combine some or all of the measurements from other goal bars and adds them to a score which shows how close a user is to receiving a reward. Since goals are personal, the calculation is based on the user's efforts toward achieving the user's personal goals. The rewards can also be customized in their type and content.

The Staying Sharp module can provide the user with brain fitness exercises and mind games that can stimulate the brain to maintain and/or improve a variety of cognitive skills. A brain wellness program can include multiple modules such as the Staying Sharp module for brain fitness, the Fun and Relaxation module and non-cognitive stimulating modules such as the Staying Fit module for managing physical fitness. In accordance with the invention, customization of the Staying Sharp module (as well as any of the other modules) can occur on four levels: 1) The selection and composition of exercises and games offered can be customized based on the health goals specified by the user; 2) The content of the exercises and games can be customized based on information obtained from the user's profile; 3) The levels of difficulty of each exercise can be customized as the user performs the exercise and the system can “remember” where the user left off and restart the user at an appropriate level the following time they get this exercise; and 4) Any of the rewards (or awards) provided to the user during the course of their training or after completion of a training exercise can be customized based on information obtained from the user's profile. Alternatively, a caregiver can specify starting levels, exercise period and duration (for example, daily and for 40 minutes), and other parameters that can be used for scoring the user's performance and progress (example: clock or no-clock) on each exercise.

Based on the health goals that are specified for the user, the software system can select and offer programs containing sets of exercises that are consistent with their goals. The programs can be predefined programs, programs determined from templates, health goals and user information or programs determined by a program design algorithm. For example, if the user has a goal to improve his attention, exercises and games that train attention can be selected and configured into the schedule proposed for the user. The system can build a usage database which can store usage data for each user (for example, in a usage profile). This database can include the specific exercises performed, when they were performed, for how long the exercises were performed, highest levels of performance or scores, and how successful the user was in performing the exercises. The database can be used to customize the composition of the exercises recommended by the system as part of the wellness program so that a user doesn't stick just to one or two exercises. For example: Each time a user performs a certain activity/exercise, the system can record that the user performed such activity/exercise, when the user began and ended, how many times the user performed such activity/exercise during that time and the results of each attempt. The overall duration of the activity/exercise can also be recorded and if it is an exercise or certain games, the highest and lowest levels which the user reached can also be recorded. The next time the user attempts to start performing the same activity/exercise, the system can check the usage database to see when the user recently performed that specific activity/exercise and how many times in the last week or month. The user's highest result (score) from a range of past performances can also be checked. Three tables can be used by the software to determine how to respond to the user's attempt to perform an exercise. A Frequency table can have the number of times the exercise was performed by the user and the total duration spent on such exercise in a given time (Week or month). The first field in this table can have entries such as Very Frequently (VFR)=“30 times in the last month”, Frequently (FRQ)=“15 times in the last month” Routinely (RTN)=“10 times in the last month” Not Frequently (NFR)=“4 times in the last month”, Rarely (RAR)=“3 times or less in the last month. The second field can be the duration of time spent. The third field in this table can be the response code. A second table can be the Response table that is used to determine how the software will respond to the attempt of a user to perform an exercise based on the number of uses in the last month or week and the most recent use. This table can include the following values:

NR=No Restrictions—the system will allow the user to do the activity/exercise with no restrictions and will move on to the next step of checking when his last performance occurred and what was the highest level he/she reached.

SA=Suggested Alternatives—the system will advise the user that he/she has been doing this activity/exercise very frequently and recommend doing certain other activities/exercises. If the user disagrees and wishes to perform the activity/exercise, the system will move on to the next step of checking when the user last performed the activity and proceed with the adjustment of the starting level as described above. Otherwise an alternative activity/exercise which the user has not done recently or too frequently will be offered.

RA=Restrict Activity—the system will tell the user that this activity/exercise is not available at this point. It will suggest doing certain other activities/exercises which the user will be able to choose and start doing right away.

The third table can be the performance level (or difficulty level) table which can include rules for selecting the starting level (performance or difficulty) of the user for a particular exercise as a function of how recently the user performed a particular exercise or activity and the highest level of performance achieved by the user. Entries could be: “In the last hour”, “In the last 6 hours”, “In the last 24 hours”, “In the last 48 hours”, “In the last week”, “In the last 14 days”, etc. Each entry in the table can be associated with a number of levels that the system will subtract from the user's most recent highest level for his/her next exercise. If the user's last performance was recent (Within the last 24 hours) the starting levels can be close to the user's highest level (for example, Zero to five levels below). If the user's most recent performance was between 7 days ago, the starting level can be farther from the user's highest level (for example, Eight levels below). If the user's most recent performance was more than 30 days ago the starting level can be lower (for example, 12 levels below the most recent highest level). Alternatively, a caregiver can select a set of exercises and activities for the user to perform, the duration and level of difficulty for each exercise, how frequently each exercise should be performed, etc.

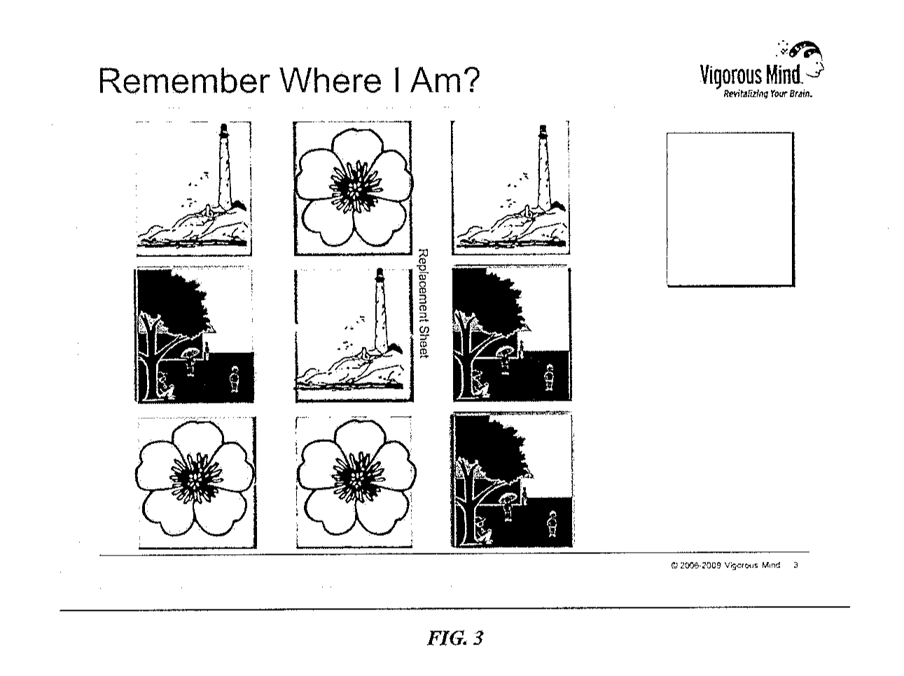

In accordance with one embodiment of the invention, the software system can offer a variety of exercises. The exercises can incorporate content including graphic images, video, language, and audio which can be customized based on information from the user's profile. For example, one exercise is similar to the game “Concentration”, which can be used to train attention and develop visual spatial memory. The user can be presented with images of objects and the user is asked to memorize the objects and their location. FIG. 3 shows a non-customized version of the concentration exercise. As you can see, the objects in FIG. 3 are flowers, a sunset, and a forest in winter.

FIG. 5 shows an example of a customized version of the same exercise, in this example where the user's profile indicates that the user lived in Brooklyn or that Brooklyn is a favorite place. As compared with FIG. 3, the images shown in FIG. 5 can be pictures of places in Brooklyn. These places can be familiar to the user or, because of their style and/or appearance, remind the user of Brooklyn.

The pictures of Brooklyn can be stored in a content database that allows the system to select content as needed to customize the exercises or activities. Where the user's profile includes one or more preferences or provides personal information that can match one or more attributes of the content in the content database, the system can automatically select or preselect content to be used to customize the exercises or activities and the rewards. While initially, the content can be randomly selected, or more generally selected (for example, based on a user's age, generation, or gender, over time, as more information is obtained from the user or about the user, additional content can be selected using the information in the user profile. In addition, the user's ranking or rating of the content can be obtained and used to further improve the customization for the user. The user's profile can store links or pointers to content stored in the content database and the content database can include either the content or a link, such as a URL or other pointer to the content stored at another location.

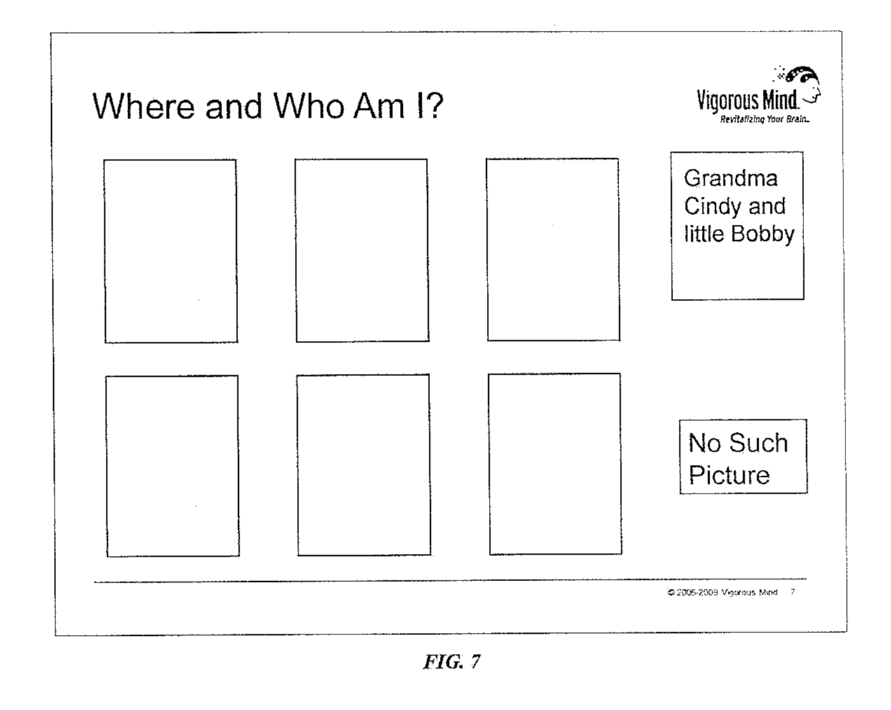

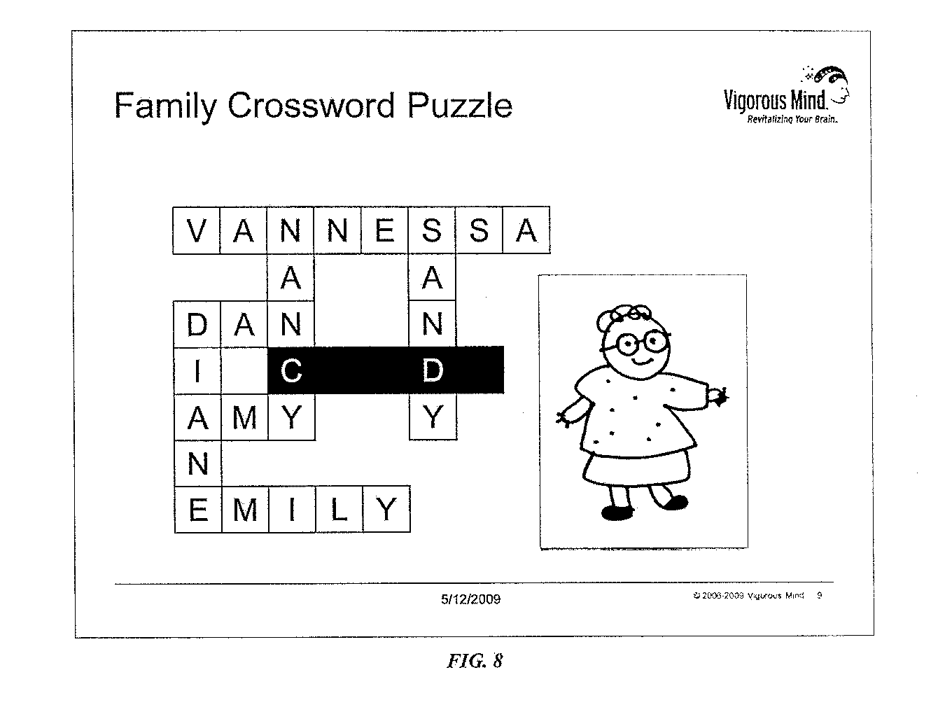

In an alternate embodiment of the invention, as shown in FIG. 6, the Concentration exercise can include faces of family members of the user, personal heroes or political figures determined as a function of information included in the user's profile. The family members can include, for example, parents, sibling, children, grand children and great grand children. Personal heroes can include, for example, sports heroes (e.g. Jackie Robinson, Hank Aaron, Babe Ruth, and Lou Gehrig). Political figures can include current and past US Presidents, leaders of foreign countries, religious leaders, and cultural heroes. In a higher level of the exercise, the pictures can appear with the (text of the) name of the family member (or friend or person) instead of a second picture so the user can train on and practice connecting a face and a name of a family member (or a friend). Other exercises can also train the user to associate faces or pictures with names or other text. A variation of this exercise can be used to train the users on recognizing and memorizing names of people—FIG. 7 shows the exercise memorizing family members' names and faces. FIG. 8 shows an alternate exercise in the form of a cross-word puzzle where the clues can be pictures, relations or definitions (Ex. My youngest son, the President in 1937). This exercise can be customized by using familiar images, such as, of family members, personal heroes or famous people and familiar places.

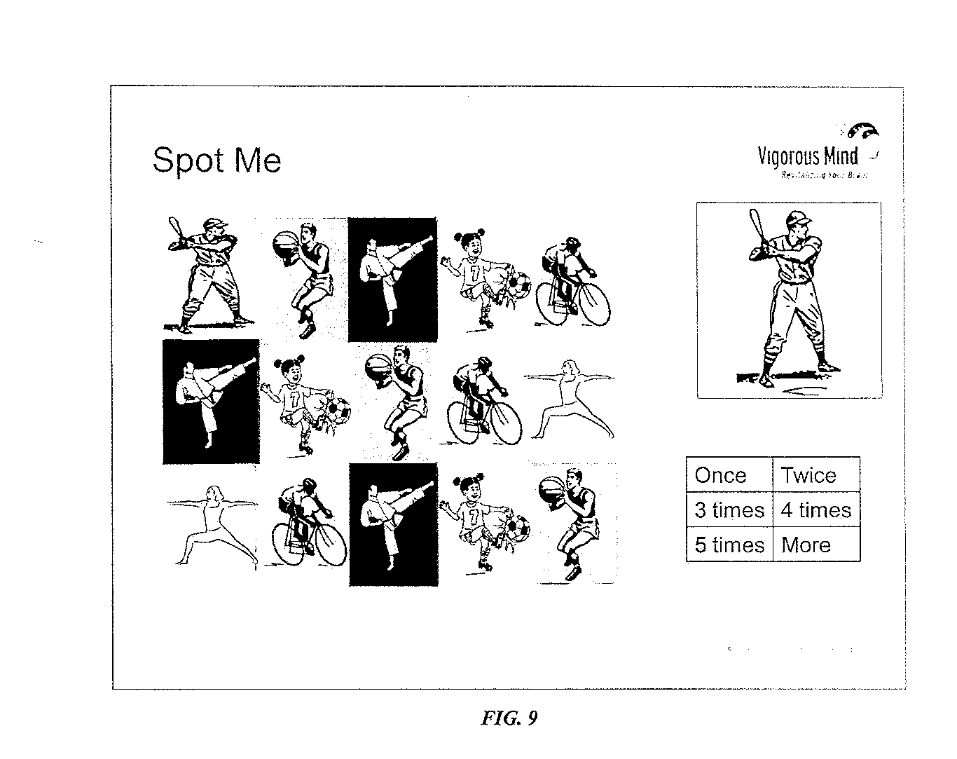

In accordance with one embodiment of the invention, another exercise can instruct the user to memorize an object or a face and then the system can instruct the user to locate the object or face among a group of other objects and faces. FIG. 9 shows a version of this exercise that has been customized for the user who indicated that his favorite baseball team was the Brooklyn Dodgers and his favorite player was Jackie Robinson.

In alternative embodiments of the invention, exercises directed to maintaining and/or improving auditory capabilities and functions can be provided. These exercises and activities can use sounds, such as music, audio and video clips, as the primary content presented to the user. These exercises can be customized, such as by using the user's favorite music, or through audio or video clips that include the voices of relatives or famous people that might be familiar to the user.

Staying Connected

The Staying Connected module can provide the user with activities that enable the user to socialize using the software system and other tools available on the internet. This can include activities such as using email which provides addressee pictures, such as of a family member or a friend, that can help the user recognize and remember the identity and name and other important information about the addressee.

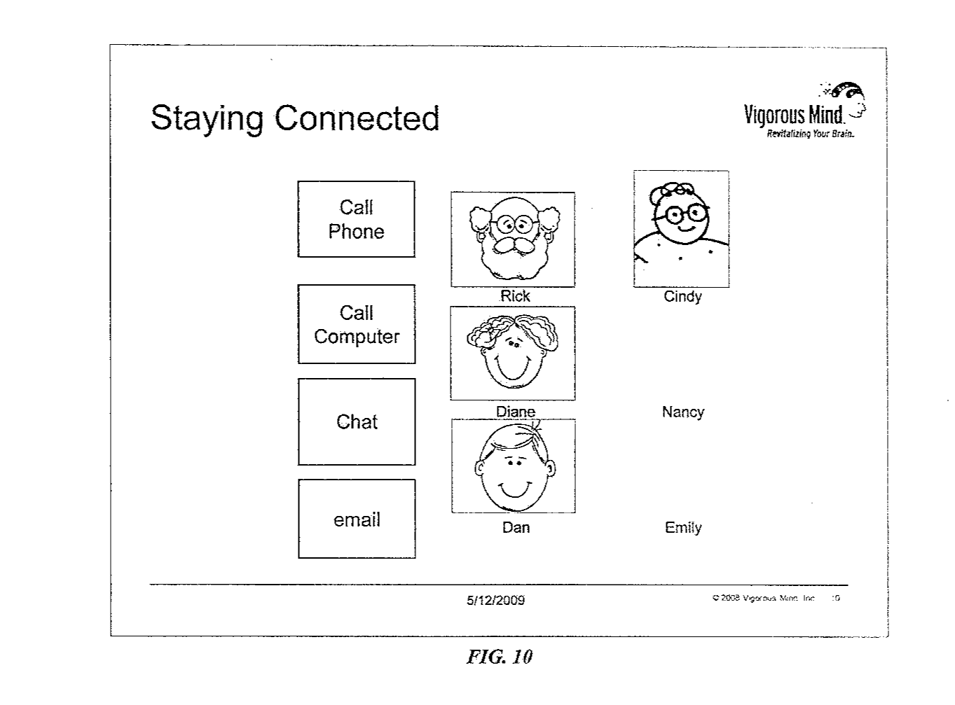

In accordance with one embodiment of the present invention, FIG. 10 shows a simplified connectivity center where the user can choose the mode of communication and that provides pictures (in addition to names) of people from the user's profile (family, friends, caregivers) as part of the connectivity center. In addition to the picture of each person and their name, a recording of several messages in their voice can be used to further customize the connectivity center. For example, when an email comes from a granddaughter, the user can hear their granddaughter say: “Hello grandpa, this is Victoria and I sent you an email”. The connectivity center can also use internet communications tools such as Skype or Facebook.

Fun & Relaxation

The Fun and Relaxation module can provide access to fun and relaxing activities. This includes activities with simple, easy and/or enjoyable exercises that can promote user relaxation. These activities and exercises can be customized, based on information obtained from the user's profile, to make them more fun and relaxing. Examples of Fun and Relaxation module activities can include Recollections, Music and Hobbies.

The activities and exercises selected for a user can be based on input from the user, such as information obtained through occasional interviews of the user and the information obtained from the user's profile. Additional information can include feedback obtained from the user after the performance of one or more of the selected activities.

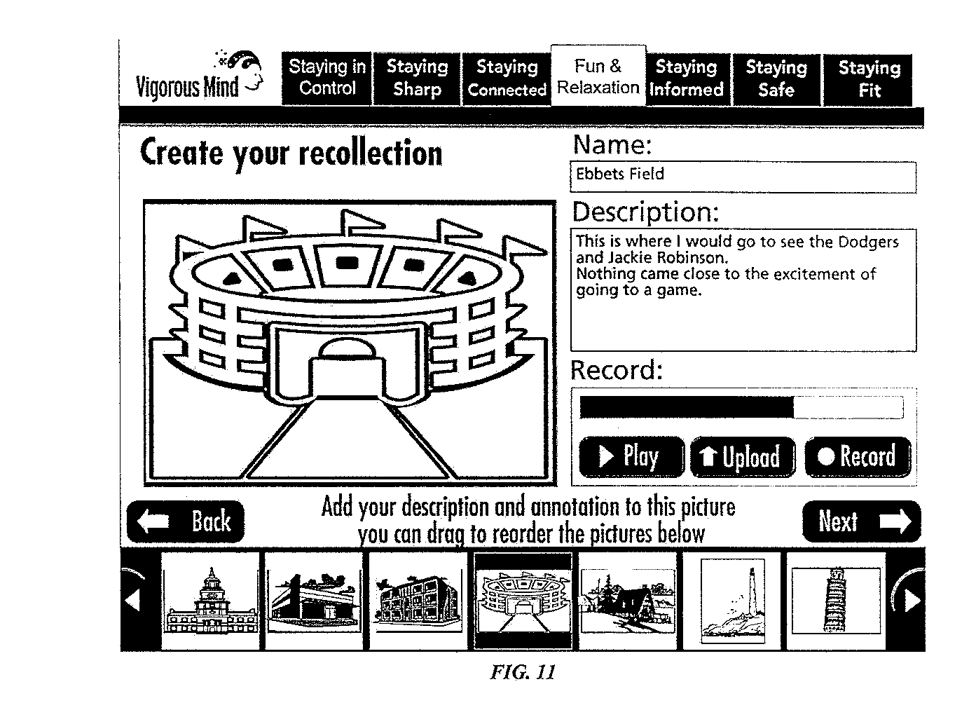

The Recollections module can include activities that are intended to bring back memories by presenting the user with images that can be organized in the form of albums that contain pictures, voices, stories, and videos related to the user's profile. The user can create albums or watch albums that were created by the system or by other people that can include content related to the user's life. As shown in FIG. 11, the software system can enable a user to create a Recollections album by adding pictures and enabling the user to write or record memories and information related to the pictures. The user can also combine pictures from Recollections albums created by the system with the user's own pictures and record his or her life story.

In accordance with one embodiment of the present invention the system can create Recollections albums which can be customized based on the user's profile. So for the user who indicated they had fond memories growing up in Brooklyn, N.Y. and admiring the Dodgers, the software system can select a Recollections album that can include pictures of Dodger players, Ebbets Field as shown in FIG. 11, or other relevant pictures. The system can combine Recollections with music, for example, the user's favorite music based on information obtained from the user's profile.

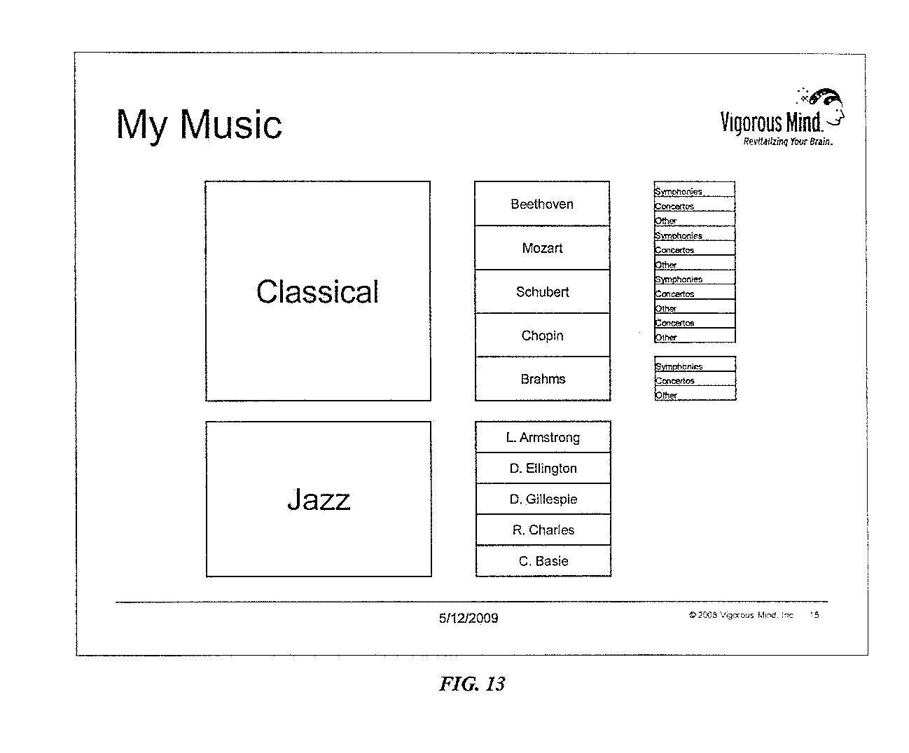

The My Music module can provide the user with different types of music, based on information obtained from the user's profile (FIG. 13). The system software can build the screen as a function of information, such as music preferences or favorite musical artists identified by the user. Where music preferences are not found in the user's profile, the system can either prompt the user to input their music preference or the system can select the music based on other information obtained from the user's profile, such as, the time period when the person was born, where they grew up and any other information in the profile that might suggest musical taste. Music sources can include free internet radio stations, for example Pandora (www.pandora.com).

The Hobbies module can provide the user with information about their hobbies as indicated in the user profile. The software system can use the internet to identify and suggest sources of information about the hobbies and interests of the user. The sources of information can include online magazines, museums, videos, blogs, and stories related to the hobby.

The Staying Informed module can provide the user with information and content about current events as well as activities and events relevant to the user's life. One activity within the Staying Informed module can include a Web-surfing activity. The Web-surfing activity can present the user with a number of general information websites offered to all users (or a broad audience of users, for example, senior citizens) but certain websites can be chosen as a function of information obtained from the user's profile. The Web-surfing activity can, for example, present three groups of buttons which make accessing a website one touch/click away and two of the three types of websites can be customized based on information obtained from the user profile. For example, the general websites can include search engines and websites, such as, Google, Wikipedia, Weather, WebMD; the second group can be system selected or recommended web sites that are chosen based on the user profile, for example, the history of baseball, the history of the Dodgers or Ebbets Field; and the third group can be user selected websites, those that the user can add as the user's favorite websites.

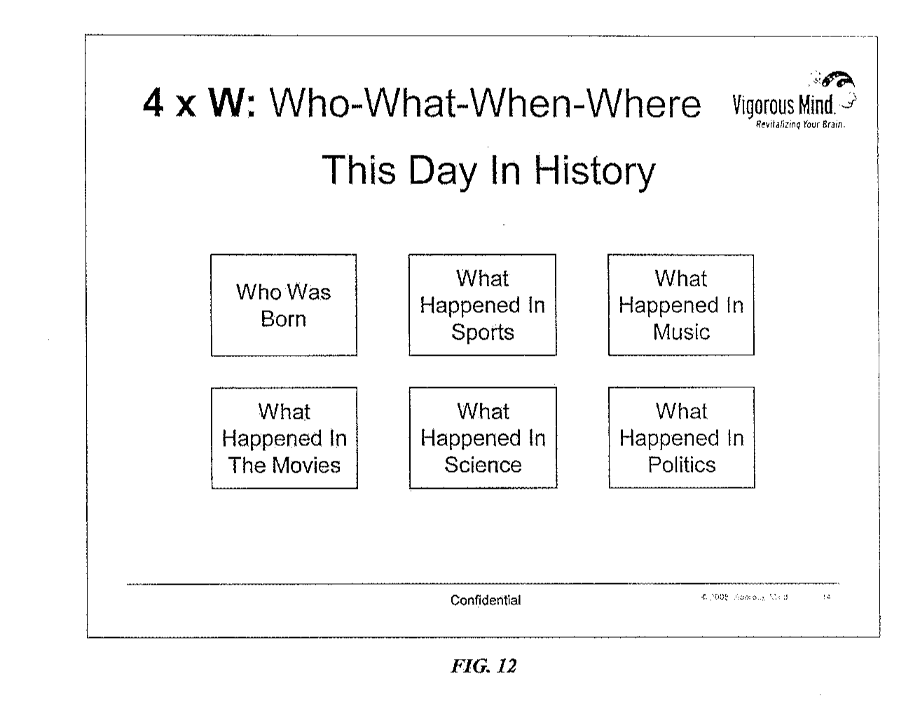

The 4×W module can provide the user with stories about what happened in history on the current day or during the current week in areas of interest to the user based on information from the user's profile. FIG. 12 shows an example of the 4×W module which can include stories that are of general interest and certain stories that are specifically chosen based on the user's profile. Stories that are specifically chosen for the user can include stories with key words or attributes that match or are related to information from the user's profile, such as times and places where the user lived, favorite teams, favorite players and heroes, artists, movies, etc.

The Staying Safe module can present information to users about issues that concern populations at risk, for example, senior citizens, people with a high likelihood of contracting a disease or ailment, patients recovering from disease or trauma and groups having similar financial, social or economic issues.

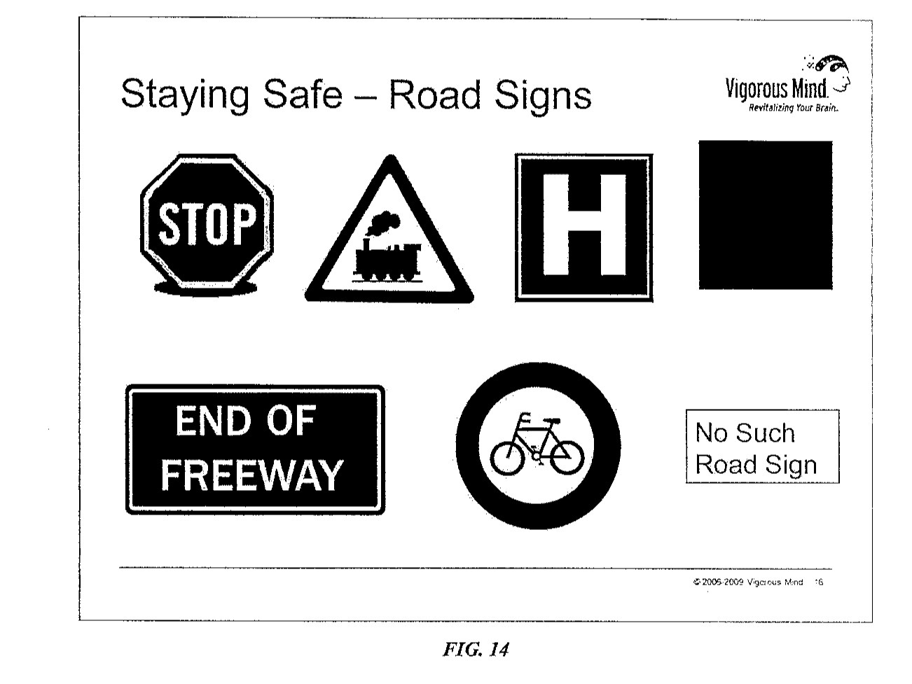

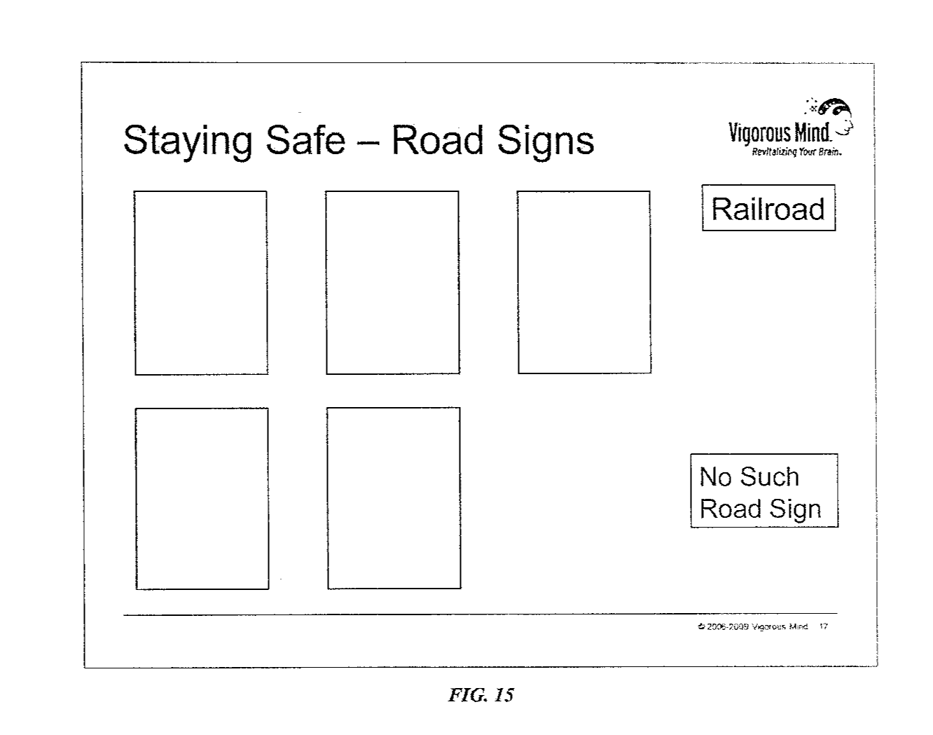

The Staying Safe module can include two activities, Safe Driving and Take-Care. Both activities can be customized based on the user health goals and information obtained from the user's profile. The Safe Driving activity can provide driving exercises that are selected as a function of the user's age and other information (does the user wear glasses or have physical handicap) where response time and divided attention become a key objective in old age (versus judgment, that is more important to train at a younger age). FIGS. 14 and 15 are examples of an exercise that trains visual spatial skills and trains road sign recognition. The signs can be customized based on where the user lives or be specific to a locale. For example: the sign for Freeway is a California sign. The Take-Care activity can provide the user with relevant information about how to better take care of themselves, their family and friends. For example, one Take-Care activity can provide education to Senior Citizens about avoiding falls and about health issue that are related to their age. The Take-Care activity can provide patients recovering from disease or trauma with information and education specific to their disease or trauma. The system can customize the Safe Driving and Take-Care activity based on information obtained from the user's profile.

The Staying Fit module can provide the user with physical fitness exercises, activities and information that can help maintain and improve the user's physical health.

The Staying Fit module can include two activities, Physical Fitness and Healthy Nutrition. Both, the Physical Fitness activity and the Healthy Nutrition activity can be customized based on the user health goals and information obtained from the user's profile. The Staying Fit module can interact or communicate with Fitness and Health equipment to keep track of the user's performance and progress in a particular fitness and health program. For example, if a user uses a wearable device that tracks the user's physical activity (such as Gruve by Muve, Inc. Minneapolis, Minn.), information from the device could be downloaded (imported or otherwise received) into the system for use by the Staying Fit module. The user's progress in a program requiring a defined level of physical activity can be determined from data received from the wearable device and displayed by the system and can be incorporated in a rewards program to provide incentives for the user. If a user performs physical fitness activities through other devices that can record his/her activities, such activities will be imported into the system and used by the Staying Fit module so they can also be reflected in the progress reporting and incentives provided by the system.

The Healthy Nutrition activity can include information and advice on food and food preparation as well as tools to monitor weight and other dietary concerns. This information can be customized based on the user's personal health and wellness goals and information obtained from the user's profile.

The software system according to one embodiment of the invention can be implemented as web based application that can be accessed by a user through a user terminal using a client application such as a commonly available web browser. In this embodiment, the user terminal can include any hardware device that can implement a web browser (for example, a personal computer, laptop computer, or handheld device) and the functionality of the system can be adjusted according to the capabilities of the user terminal. In addition, the user terminal can be connected to sensor devices and alternative user input devices that can provide additional information (for example, physiological and biological health monitoring) and improved user experience during exercises and activities (for example, a steering wheel and joy stick). In an alternative embodiment of the invention, a proprietary user terminal can be provided.

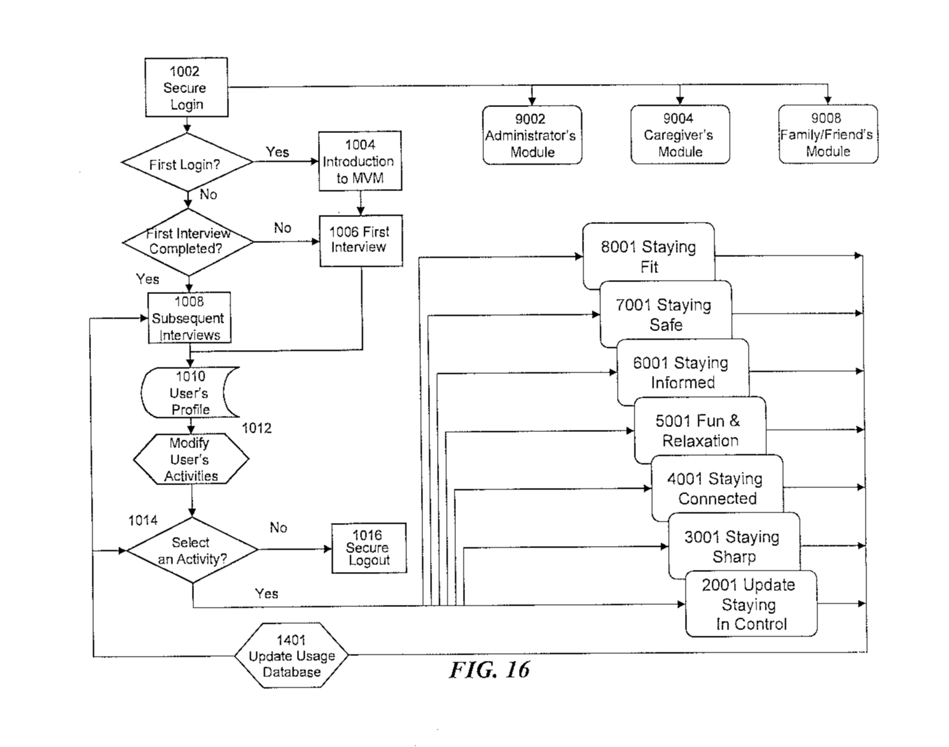

FIGS. 16-19 show flowcharts of one embodiment of the process flow and method according to the invention. The process according to the invention can be implemented on an application server that presents the application as a series of web pages that are presented according to a defined application flow. The application server can include a Windows IIS based system or a Linux Apache web server.

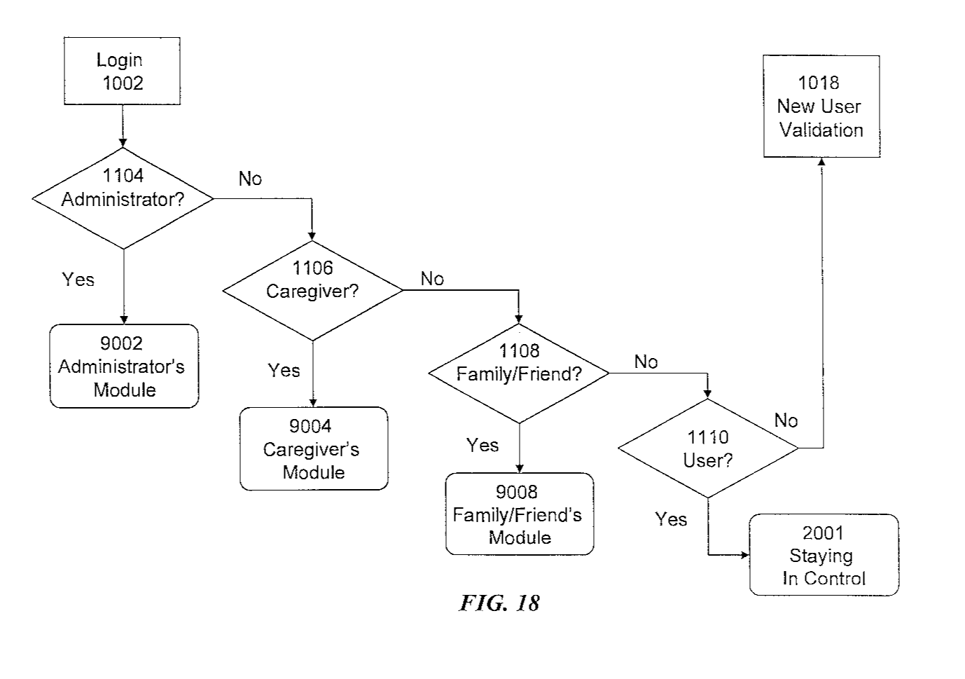

FIG. 16 shows the general flow of a system according to one embodiment of the invention. At step 1002, the user logs into the system by providing their login ID and a password. The login process 1002 allows for different types of users to login to the system including users, administrators 9002, caregivers 9004, and family and friends 9008. The login process 1002 is shown in more detail in FIG. 18. After the user logs in, the system determines whether this is the first time that the user has logged in, for example by checking a first time attribute or looking to see if the user log is empty. If this is the first time the user has logged in, the system proceeds to step 1004 where the user is provided with an introduction to the system. The introduction can provide the user with basic information about the system and how to use it. The user can be provided with the option of skipping the introduction.

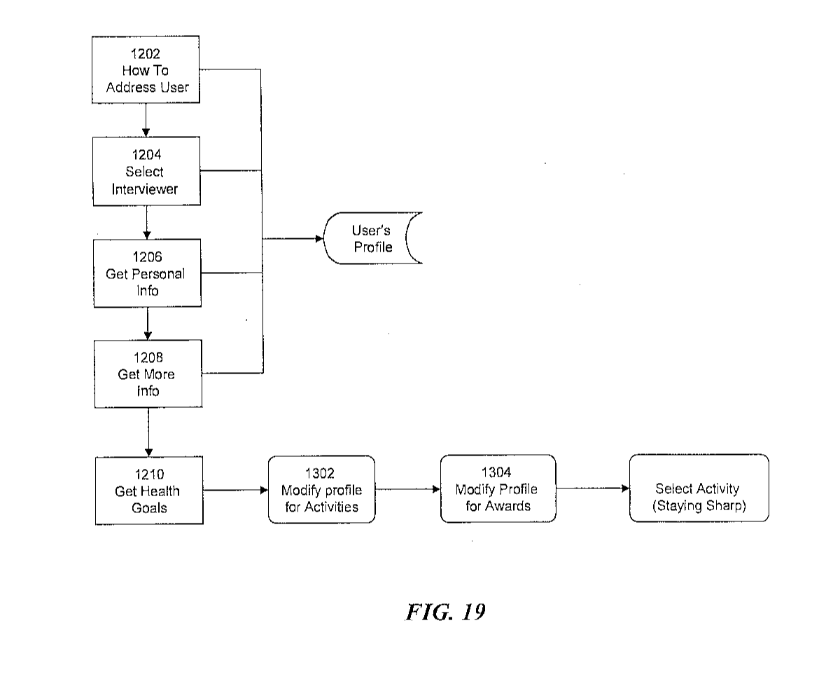

Next, the system proceeds to step 1006 and the first interview. The first interview 1006 allows the system to interact with the user to obtain some basic information about the user. During the first interview 1006, the system can prompt the user for information about themselves, their family and friends and the information obtained from the user can be used to determine information about the user that can be stored in the user's profile. One example, of a first interview is shown in FIG. 19. The first interview can be used to obtain basic information about the user, so that the user can interact with the system in a meaningful way. Some or all of the information to be obtained during the first interview can be input by a user's family member or a caregiver. The system can determine whether the user's profile contains the predetermined minimum amount of information to enable the system to customize the program before interacting with the user. If the system has determined that the user's profile includes the predetermined minimum information, the system can allow the user to skip the first interview. However, upon subsequent logons, the user can continue to be prompted for additional, non-essential information.

If the system determines that it is not the user's first time logging into the system or that the first interview has not been completed, the system can proceed to step 1008 and begin a subsequent interview of the user. Unlike the first interview which is intended to obtain basic information needed for the system to interact with the user, the subsequent interviews are designed to obtain additional information about the user and the user's preferences in order to help facilitate customization of the exercises and activities. The system can include a predefined set of subsequent interviews that can be presented to each user in a predefined sequence after the user's first login. Alternatively, the system can randomly select one of the subsequent interviews from a set of predefined interviews for presentation to the user at their second and subsequent login.

In accordance with one embodiment of the invention, a user profile is predefined with a complete list of possible user attributes and for each attribute one or more questions or user prompts are provided to be presented to the user in order to obtain the attribute information. The prompt can be as simple as “What is your favorite sport?” or “what is your favorite baseball team?”

A prompt can be a sequence of statements, such as, “Are you a baseball fan?” and if yes, “What is your favorite baseball team?” After the user input the “Dodgers,” the system can store the attribute, Favorite Baseball Team=Dodgers. If the user indicated that they are not a baseball fan, the system can store the attribute, Favorite Baseball Team=none. Where the user indicated that the Dodgers where their favorite team, additional prompts can be provided to inquire about the era of the team the user is a fan of (if any), as well as favorite players and games. The prompts can be selected based on information obtained from the user profile, such as whether the user is male or female and whether the user's home town or a place where they lived had a baseball team. The system's database can be populated by data about each state. Such data can include key metropolitan areas, sports teams in each metropolitan area, their coach, key players, games and scores in each season, and their achievements in each season. For each state colleges in the state, their sports teams, coach, key players, games and scores and achievements in each season. So, if the user grew up in Brooklyn before 1958, the system could prompt the user “I see you grew up in Brooklyn, were you a Dodgers' fan?” whereas, if the user grew up in a town that did not have a baseball team, the system could prompt the user “Are you a baseball fan?” As part of the first interview or one of the first subsequent interviews, the system can prompt the user about their interests in general. For example, the system could ask to select (such as by checking a box or a radio button) their interests from a list of interests. The list of interests can, for example, include sports, history, news, politics, and the arts. This information can be stored in the user's profile and used to select subsequent interview topics and prompts.

After the first interview, the user's profile is created 1010 and the user's training program, based on their personal health goals and/or the treatment program 1012 defined by their family member or caregiver, is created and stored in or associated with the user's profile. After a subsequent interview, the user's profile is updated 1010 and the system evaluates the user's profile to determine whether the changes to the user's profile result in a change in the user's training program 1012. If necessary, the user's training program is updated at step 1012. The update can also include the selection of content to be used to customize the training program exercises and activities. For example, where the user indicates that their favorite baseball team is the Brooklyn Dodgers, the user's profile can be updated to indicate that content can be selected from a set of Brooklyn Dodgers content. For example, the next activity or exercise that the user participates in can be customized with pictures or video of the Brooklyn Dodgers and the next reward or award the user receives can be a picture or clip from a Brooklyn Dodgers game. Over time, as the user's profile becomes more complete, the system can use the profile to provide content that is more relevant and interesting to the user.

At the next step 1014, the user can select a module to participate in an activity. In accordance with one embodiment of the invention, the system can by default, present the user with Staying In Control module 2001 and provide the user with the Orientation Area, “to do” area and the Fitness and Reward Status Area as shown in FIG. 2. Each module can have a navigation strip at the top, such as shown in FIG. 2 that can allow the user to navigate directly to any other module.

From the Staying In Control module 2001, the user can select any of the other modules, Staying Sharp 3001, Staying Connected 4001, Fun & Relaxation 5001, Staying Informed 6001, Staying Safe 7001, and Staying Fit 8001. Each module can present the user with a menu (or a series of menus) that enables the user to perform one or more activities or exercises. Each module can include a menu item or other user interface element that can allow the user, either directly or indirectly, to return to the Staying In Control module 2001.

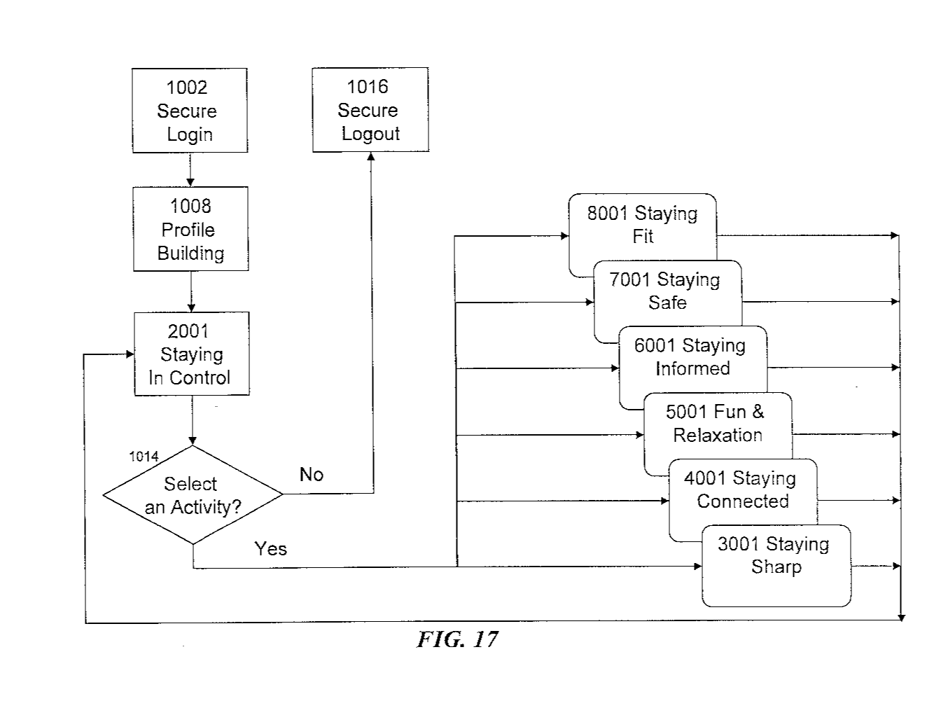

FIG. 17 shows a flowchart of a process flow similar to FIG. 16. As shown in FIG. 17, the user securely logs in at step 1002 and is optionally, interviewed at step 1008. In one embodiment of the present invention, the system can be configured to randomly initiate the subsequent interview process 1008. In this embodiment, after the user login 1002, the user is automatically presented with the Staying In Control module 2001 and can begin their training program. Upon exiting any of the other modules, Staying Sharp 3001, Staying Connected 4001, Fun & Relaxation 5001, Staying Informed 6001, Staying Safe 7001, and Staying Fit 8001, the user is returned to the Staying In Control module 2001.

FIG. 18 shows a flowchart of an example of the secure login process 1002. At step 1002, a user or other person logs into the system. Upon receiving valid login and password information, the system determines whether the person is an Administrator. If the person is an Administrator, the system presents the Administrator with the Administrator module 9002. The Administrator module 9002 allows the Administrator complete and total control over the configuration and operation of the system. The Administrator can add or delete users as well as give caregivers and family members login credentials to access and make changes to specified user accounts.

If the person is not an Administrator, the system determines whether the person is a Caregiver. If the person is a Caregiver, the system presents the Caregiver with the Caregiver module 9004. The Caregiver module 9004 gives the Caregiver access to the accounts of one or more users, in order to supervise and administer care to those users.

If the person is not a Caregiver, the system determines whether the person is an authorized Family member (or authorized friend). If the person is an authorized Family member, the system presents the authorized Family member with the Family member module 9008. The Family member module 9008 gives the authorized Family member access to the accounts of one or more users, in order to help supervise and administer care to those users.

If the person is not an authorized Family member, the system determines whether the user is a valid user. If the user is a valid user, the system checks the user's profile and presents the user with the appropriate module, for example, the introduction module 1004, the first interview module 1006 or the default activity module, such as Staying In Control 2001. The system can proceed as discussed with respect to FIGS. 16 and 17.

FIG. 19 shows a flow chart of an example of the first interview module 1006. The first interview module 1006 can be designed to prompt the user for basic information needed for the system to operate. While in some embodiments, the system can be designed and configured to use default information to proceed and interact with a user, the system cannot provide full benefit if it is unable to customize itself according to the preferences of the user. For example, the system can prompt the user for information about how the user desires to be addressed by the system at 1202, such as “Mr. Smith,” or John, or by nickname. After the user specifies how they desire to be addressed, this information can be stored in the user's profile and system data can be refreshed so that subsequently the user is addressed as requested.

Since the system will interview the user periodically, the system can allow the user to select the character who will conduct the interviews at 1204. The interviewer can be the system, a buddy or predefined character having specific attributes (baseball player, football player, rock star) or a family member. Where the user chooses to be interviewed by a family member, the system can change the way the system addresses the user, for example, if the interviewer is a child, the user is addressed as “Mom” or “Dad” and for a grandchild, as “Grandma” or “Grandpa.” After the user specifies the interviewer, this information can be stored in the user's profile and system data can be refreshed so that subsequently the user is interviewed by the selected interviewer.

After the interviewer is selected, the system can begin to obtain some personal information at 1206. This information can include current and historical information about the user. Current information can include where the user currently resides, whether they work or are retired. Historical information can include the user's date and place of birth. After the system obtains some basic information, the system can prompt the user for more personal and historical information 1208, including information about where they have lived, information about their family, their education and their occupation. The prompts during the interview can be selected based on information obtained from the user's profile. For example, where a user selected a grandchild as the interviewer, the system can skip some prompts (such as, do you have any children or grandchildren?). This information can be stored in the user's profile and system data can be refreshed so that it can be used in subsequent processing.

At 1210, the system can prompt the user for information about their personal health goals. This can include specific questions about their desires to maintain and/or improve physical and/or cognitive abilities. Based on the user's responses to the questions, the system can select a training program or assist the user in developing a training program.

At 1302, the user's profile is updated with the training program. At 1304, the system can analyze the user's profile to determine the type of content and rewards that might be preferred by the user. After the preferred content is determined, the user can be presented with the Staying In Control module.

In accordance with one embodiment of the invention, each time a user performs an exercise, the system can remember (store in the user's profile) the level that the user reached and the next time the user performs the same exercise, the level of difficulty can be selected to challenge the user at an appropriate level. The customized (level of exercise) elements in the content of the exercises can be randomly selected from the user's profile unless a caregiver (family member or friend) decides that the system should use the same elements multiple times to allow for users who are suffering from specific condition (such as, Alzheimer's disease or a recovering traumatic brain injury or stroke) to enable the patient to start recognizing places and people from their past.

In accordance with one embodiment of the invention, the system can be configured whereby a user becomes entitled to a reward by performing activities (or specified number or minutes of activities) towards achieving the user's personal health and wellness goals. The character of the reward can reflect the portion of the activity the user completed as well as the user's degree of success toward reaching certain benchmarks while performing the activity. The character of the reward can also reflect the contribution and relevance of the activity towards accomplishing his/her health goals.

In accordance with one embodiment of the invention, there can be many kinds and types of Rewards defined within the system, for example, stories or jokes, pictures, video clips, music, radio clips, games, and monetary rewards (including cash, discount coupons, gift certificates, tickets to events and restaurants, meeting with celebrities, mileage and program points).

In addition, each reward can be given one or more reward attributes including a reward value to the user. The Reward value can be, for example, determined by six parameters or reward attributes, 1) the Degree of Relevance 2) the User Reward Feedback 3) Wish List 4) the Reward Duration 5) the Monetary Value 6) The Emotional value. These attributes can be stored in the user's profile or a content database associated with the user.

The Degree of Relevance can be determined by how close the reward is to the user preferences as obtained from the user's profile. For example if during the interviews the user indicated that he or she is a basketball fan and that their favorite team was the Boston Celtics in the Larry Bird era, then the system was able to designate a video clip showing Larry Bird and the Celtics winning a game against the LA Lakers, as having a very high Degree of Relevance to this user. A video clip of a Celtics game from a different era would have a lower Degree of Relevance to this user.

The User Reward Feedback can be obtained by prompting the user for feedback or a reward rating, each time the user receives a reward. The user can be asked to rank or rate the reward and the Reward Value can be updated accordingly. For example, if the user indicated that the feedback regarding the Celtics video clip was more positive than the feedback on an “I Love Lucy” video clip reward; this information can be recorded and used to weight the Reward Value of the Celtics game video clip. The system in accordance with one embodiment of the invention can prompt the user to create a Wish List of rewards, for example, from a list of possible or available rewards. The system can then, based on this Wish-list, assign a reward value to each such reward based on its place on the Wish List—the reward at the top of the list representing the most valuable one in the eyes of the user.

The Reward Duration can be measured in units of time (such as, minutes and seconds) and it can be presumed that there is a direct and positive correlation between the Reward duration and the Reward value. The longer the duration of the reward, the more valuable it is to the user.

The Reward Monetary Value can be measured by the cost of a reward in currency (Dollars) or currency (Dollar) equivalents. In addition, some types of rewards assigned the same currency value can present different values to a user. For example, a discount coupon to a specific store which is not preferred by or desirable to the user can be assigned a lower monetary valued than a gift card to all the stores in a mall.

The Emotional Reward Value can be related to the Degree of Relevance. For example: Getting the user a ticket to a Celtics game would have a high emotional value but getting him to meet with the Celtics players would have a much higher value and meeting Larry Bird in-person would likely have the highest value. This can also be reflected on the Wish list created by the user.

The persistence and accomplishments of the user in completing their training program exercises for a given period can be used to determine which reward tiers (based on the Reward Value) can be granted to the user. For example: every time a user completes a training session, user can be awarded a reward from tier 10. If during the training the user was able to break a record (improved their performance or score over prior sessions), the user can be given a reward from tier 9. If the user completed a series of training sessions and accomplished a health goal, the user can be given a tier 8 reward.

The system can keep track, for each user, what rewards the user received and as the user makes progress towards achieving their health goals, the awards can be selected from one or more levels, tiers or values according to a predefined program that is intended to reward and encourage participation and hard work in completing their training program.

For example, for a user who is a Larry Bird era Boston Celtics fan, who also loves “I Love Lucy” and classical music, in particular Beethoven's 5th Symphony and the “Emperor” 5th Piano Concerto, his health goals are to regain his cognitive abilities and not miss meetings of AA which helps him to stay in control and avoid drinking (alcoholism is associated with memory problems). Table 1 provides an example of how the system can translate the user's performance and progress into specific rewards:

TABLE 1

| Task | Reward | Example |
|---|---|---|
| Completed | Tier | of Reward |
| Regular Brain Wellness Training Session | 10 | A 3 minute clip of basketball or 2:45 minutes of a |
| | | Mozart symphony |
| Regular Brain Wellness Training Session with an | | A 3 minute clip of the Boston Celtics playing or 3 |
| improvement in a score in certain exercises | 9 | minutes of a Beethoven symphony |
| Performing three sessions as scheduled or | 8 | A 5 minute clip of the Boston Celtics playing or 5 |
| attending two sessions of AA | | minutes of a Beethoven symphony |
| Attended three AA meetings in a row | 7 | A 5 minute clip of the Boston Celtics playing |
| | | with Larry Bird, A 5 minute clip of “I Love |
| | | Lucy”, 5 minutes of a Beethoven piano concerto |
| | | (Not the “Emperor”. |
| Performed six MVM sessions as scheduled, | 6 | An 8 minute clip of the Celtics with Larry Bird |
| showing improvement in results (or stability) and | | playing a winning game. An 8 minute clip of I |
| attended six AA meetings in a row. Was abstinent | | love Lucy. 8 minutes from Beethoven’s 5th |
| for three days. | | Symphony. |
| Performed nine MVM sessions as scheduled, | 5 | A 10 minute clip of the Celtics with Larry Bird |
| showing improvement in results (or stability) and | | playing a winning game. A 10 minute clip of I |
| attended nine AA meetings in a row. Was | | love Lucy. 10 minutes from Beethoven’s 5th |
| abstinent for a week. | | Symphony. |
| Performed 12 MVM sessions as scheduled and | 4 | A 15 minute clip of the Celtics with Larry Bird |
| attended 10 AA meetings in a row. Was abstinent | | winning a championship game. A full clip of “I |
| for three weeks. | | love Lucy” favorite episode. The full |
| | | Beethoven's 5th Symphony performed by favorite |
| | | orchestra and conductor. A $50 gift certificate. |
| Performed 30 MVM sessions as scheduled and | 3 | Tickets to a Celtics game. Tickets to a concert |
| attended 15 AA meetings in a row. Was abstinent | | where Boston 5th Symphony is played. A $100 |
| for three months. | | gift certificate. |
| Performed 48 MVM sessions as scheduled and | 2 | Tickets to a Celtics game and meeting with |
| attended 24 AA meetings in a row. Was abstinent | | players. Tickets to a concert where Boston 5th |
| for six months. | | Symphony is played by favorite orchestra. A |
| | | $250 gift certificate. |
| Performed 72 MVM sessions as scheduled and | 1 | Meeting with Larry Bird. Tickets to a concert |
| attended 36 AA meetings in a row. Was | | where Boston 5th Symphony is played and |
| abstinence for nine months. | | meeting with the conductor. A $500 gift |
| | | certificate. |

Customization of the rewards can take many forms. The user can collect bonus points towards rewards based on performance of activities that contribute to accomplishing Personal Health and Wellness Goals.

During the user's first login to the system, the user can be asked to identify his or her Personal health goals. The user can choose from predefined goals, such as: Be Sharp, Be Fit, Be Socially Connected, Improve Mood & Relax, Be Safe, Improve treatment adherence, Increase abstinence or other goals. These goals can also be set or altered by a caregiver on behalf of the user. For example, the personal health goals for a substance abuse patient could be treatment adherence and abstinence. If no goals are selected by the user or by a caregiver, the system can offer a set of default goals which can be Be Sharp. The Personal Health Goals can be used to determine the Training program which can be offered to the user in order to accomplish his or her goals. The system can also determine the Activity weight for bonus points toward receiving a reward when the user performs the activities specified in the program. Activity weights per goal can be stored in an Activity Weight Table. For example, the user selects Be Sharp as his or her top priority for his or her personal health goal, performing brain fitness exercises can add more points to the user's reward account or “bucket” than if the user listened to music. On the other hand, if the user indicated that his or her top priority personal health goal is to “Improve Mood and Relax” then doing brain fitness exercises would give the user fewer points than listening to music. The Activity Weight Table can be refined constantly as more data and feedback is received from users. Table 2 is an example of an Activity Weight Table

TABLE 2

| Personal | Activity | | | | | | | | | | |
|---|---|---|---|---|---|---|---|---|---|---|---|
| Health | Brain | Mind | eMail or | | Recollec- | My | | Web- | Driving | Patient | Physical |
| Goal | Fitness | Games | Skype | Albums | tions | Music | 4 x W | surfing | Skills | Safety | Fitness |
| Be Sharp | 10 | 9 | 7 | 5 | 5 | 4 | 9 | 7 | 10 | 6 | 10 |
| Be Fit | 3 | 3 | 1 | 1 | 1 | 3 | 3 | 3 | 5 | 7 | 10 |
| Be | 5 | 7 | 9 | 8 | 7 | 4 | 6 | 6 | 6 | 6 | 8 |
| Connected | | | | | | | | | | | |
| Improve | 4 | 8 | 8 | 8 | 9 | 10 | 8 | 6 | 6 | 7 | 7 |
| mood and | | | | | | | | | | | |
| relax | | | | | | | | | | | |
| Be safe | 5 | 5 | 6 | 3 | 3 | 3 | 3 | 5 | 9 | 10 | 6 |
| Improve | 7 | 6 | 7 | 3 | 3 | 3 | 3 | 6 | 3 | 8 | 7 |
| treatment | | | | | | | | | | | |
| adherence | | | | | | | | | | | |
| Increase | 7 | 6 | 7 | 4 | 4 | 4 | 4 | 6 | 6 | 10 | 7 |
| abstinence | | | | | | | | | | | |

Customization of content and rewards can be based on interests and preferences indicated by information obtained from the user's profile. Every time a user is interviewed, an information element indicating user interests and/or preferences can be added to or updated in the user's profile. The user's profile can include one or more attributes that indicate preferences and interests and one or more attributes can be included for each favorite interest, for example, sports, music, movie, TV program, radio program, other hobbies or areas of interest.

For example: A favorite sports attribute can include:

a. A favorite sport code: basketball=B1, baseball=B2, football=F1, golf-G1, hockey=H1, soccer=S1, tennis=T1, etc.

b. A favorite team/player in such sport. In basketball: Boston Celtics=BC, New Jersey Nets=NJ, Los Angeles Lakers=LA, Indiana Pacers=IP, etc.

c. A favorite star of the team: Larry Bird=LBIRD, Magic Johnson=MAGIC, etc.

d. A favorite game: BC-LA

So a favorite sport attribute for a Boston Celtics fan can be SB1 BC-LBIRD LL-MAGIC

Every reward stored in the system or a link to a reward can be cataloged using the same or similar parameters.

For example: A sports reward attribute can be:

a. The sports code: basketball=B1, baseball=B2, football=F1, golf=G1, hockey=H1, soccer=S1, tennis=T1, etc.

b. The teams/player featured in the clip/recording/picture. In basketball: Boston Celtics=BC, New Jersey Nets=NJ, Los Angeles Lakers=LA, Indiana Pacers=IP, etc.

c. Star of the team in the clip: Larry Bird=LBIRD, Magic Johnson=MAGIC, etc.

d. The game featured: BC-LBIRD LL-MAGIC

e. Date the game on the clip was played: Jan. 25, 1985=19850125

f. Period in the game on the clip: First quarter=Q1, second=Q2, etc.

g. The host won=W, the host lost=L

h. Duration Five minutes and 30 seconds=00:05:30

So the attribute for a reward where the Boston Celtics with Larry Bird hosted the LA Lakers on Apr. 3, 1985 and the Celtics won could be:

SB1 BC-LBIRD LL_MAGIC 19850125 Q4 W 00:05:30

The software can search the content database and compare attributes of rewards in the database with the favorite attributes of the user and evaluate each of the rewards according to the Degree of Relevance (the matching level) and the Reward Duration. The result determines the tier to which each reward will fit in the users Table of Rewards. The comparison can match reward attributes with favorite attributes of the user and this matching can be accomplished using well known Clustering algorithms.

Table of Rewards

| Reward Table | Attribute | |
|---|---|---|
| for Bob | Type | Reward Attributes |
| Tier 10 | Sports | SB1 MH-SONEIL CB-MJORDAN 19980325 Q4 W 00:02:45 |
| | Sports | SB1 LL-KABDUL NJNETS-BBRADLEY 19780215 Q3 L 00:02:55 |
| | Music | MCL MOZA SYM40 MOV1 NYP LBERNSTEIN 1978 00:03:00 |
| | Music | MCL BRAN SYM1 MOV2 BEP HFKARAJAN 1974 00:02:55 |
| Tier 9 | Music | MCL BEET SYM3 MOV4 BSO JLEVINE 2004 00:03:00 |
| | Sports | SB1 BC-PEARS LL-SONIEL 20050127 Q1 L 00:03:00 |
| | TV | COM I LOVE LUCY AT THE FACTORY 19580415 00:03:00 |
| Tier 8 | | |
| Tier 4 | Sports | SB1 BC-LBIRD LL_MAGIC 19850125 Q4 W 00:12:30 |

In an alternative embodiment, each item of content can include one or more attributes and each attribute can include a set of elements that can be used to characterize the content. For example, a video or video clip of a basketball game include an attribute that includes a set of elements that indicate it is a basketball game, between the Boston Celtics and the LA Lakers, the date of the game, whether it was a playoff or championship game, the length of the video or clip, and the names of any star players that appear in the clip. For each user, the user's profile can include one or more preference attributes and each attribute can include a set of elements that can be used to characterize the user's preferences with respect to a particular type of favorite element. For example, a Larry Bird era Boston Celtics fan can include a sports attribute that indicates the user prefers basketball, the Boston Celtics, and a date range corresponding to the Larry Bird era. In this embodiment, content for activities and rewards can be selected from the content database for this user by searching for content having elements of attributes that match the user's preference attribute. Content having more elements of attributes that match the preferences of the user can be assigned a higher reward value for the specific user. The content matching can be accomplished using known Clustering algorithms.

The customization of the rewards can be modified based on feedback received for prior rewards. One of the goals of the software system is to help users to achieve their personal health goals and at the same time to become engaged with a fun activity that can also improve their mood—alleviate their depression and reduce stress. Users can react differently and unexpectedly to rewards selected by the system and in order to aid the system to make the selection as meaningful and effective as possible, after each reward is awarded to a user, the user is asked to rank or rate the reward. This information can be used to adjust or revise the Reward Value and to adjust or revise the tier level of the rewards in the Table of Rewards of each user to reflect their new Reward value. In some embodiments, no feedback is sought from a user for rewards that have already received the user's feedback.

Other embodiments are within the scope and spirit of the invention. For example, due to the nature of software, functions described above can be implemented using software, hardware, firmware, hardwiring, or combinations of any of these. Features implementing functions may also be physically located at various positions; including being distributed such that portions of functions are implemented at different physical locations.

Further, while the description above refers to the invention, the description may include more than one invention.

What is claimed is:

1.-20. (canceled)

21. A method using reminiscence for improving the well-being of a user, the method comprising:
collecting information about the user to establish or update a user profile of the user;
storing the information about the user in one or more databases; and
providing to a client computer of the user an interface having a plurality of modules,
wherein at least one of the plurality of modules provides one or more cognitive activities to be engaged in by the user and involving reminiscence content relating to past events, places or persons,
wherein the reminiscence content is selected for use in the one or more cognitive activities based on a determination that the reminiscence content contains attributes that are relevant to the information contained in the user profile of the user, and
wherein the reminiscence content is provided to the user to assist the user in remembering important memories and promote the emotional well-being of the user.

22. The method of claim 21, wherein the attributes of the reminiscence content include a specific date, a time period, a geographic location, a building, an object or a person.

23. The method of claim 21, wherein the reminiscence content is provided by the user, a family member of the user or a caregiver for the user

24. The method of claim 21, wherein the user profile comprises user identification information, including date and place of birth, places where the user lived, schools attended by the user, profession of the user, work places of the user or family members of the user, hobbies of the user, a volunteer organization or the user or work of the user.

25. The method of claim 24, wherein the user profile further comprises user preference information, including the user's health-related goals, important memories, favorite sports, favorite sports teams, favorite sports players, favorite music, favorite music performers or favorite movies or television shows.

26. The method of claim 21, the collecting further comprising an initialization process that includes sending one or more questions to the user via the interface.

27. The method of claim 21, wherein the interface includes a module containing a plurality of cognitive exercises configured to cause the user to remember what is important to the user.

28. The method of claim 27, wherein the plurality of cognitive exercises configured to cause the user to remember what is important to the user presents images, sounds, videos or text from past time periods that are customized to be relevant to the information contained in the user profile of the user.

29. The method of claim 28, wherein at least some of the images, sounds, videos or text from past time periods are obtained from public resources.

30. The method of claim 28, wherein at least some of the pictures, sounds, videos or text from past time periods include content provided by the user, a family member of the user or a caregiver for the user and obtained from the one or more databases.

31. The method of claim 21, wherein at least one of the one or more cognitive activities includes:
presenting the user with one or more images from past time periods and having attributes that are relevant to the information contained in the user profile, and
enabling the user to organize the one or more images into a customized collection.

32. The method of claim 31, wherein the user may write messages, record voice messages or insert videos in the customized collection.

33. A system using reminiscence to improve the well-being of a user, the system comprising:
at least one server connected to a network, the at least one server containing instructions for providing an interface having a plurality of modules to a client computer of the user that is connected to the network, at least one module of the plurality of modules providing one or more cognitive activities to be engaged in by the user and involving reminiscence content relating to past events, places, objects or persons; and
at least one database connected to the network configured to store information collected by the at least one server about the user to establish or update a user profile of the user,
wherein the reminiscence content is selected for use in the one or more cognitive activities based on a determination that the reminiscence content contains attributes that are relevant to the information contained in the user profile of the user, and
wherein the reminiscence content is provided to the user to assist the user in remembering important memories and promote the emotional well-being of the user.

34. The computerized system according to claim 31, wherein the activity content presented to the user includes images, text, audio or video.
